(19) United States
(12) Patent Application Publication
(10) Pub. No.: US 2026/0160089 A1
(43) Pub. Date: Jun. 11, 2026

(54) CLEANING SYSTEM

(71) Applicant: XINGMAI INNOVATION TECHNOLOGY (SUZHOU) CO., LTD., Suzhou (CN)

(72) Inventor: Shengle WANG, Suzhou (CN)

(73) Assignee: XINGMAI INNOVATION TECHNOLOGY (SUZHOU) CO., LTD., Suzhou (CN)

(21) Appl. No.: 19/393,586

(22) Filed: Nov. 19, 2025

(30) Foreign Application Priority Data
Dec. 6, 2024 (WO) PCT/CN2024/137628
Jan. 19, 2025 (WO) PCT/CN2025/073171
Jan. 21, 2025 (WO) PCT/CN2025/073739

(51) Int. Cl. E04H 4/16; A47L 7/00; C02F 1/00; C02F 103/42; E04H 4/12

(52) U.S. Cl. CPC E04H 4/1654; A47L 7/0033; C02F 1/001; E04H 4/1263; C02F 2103/42

(57) ABSTRACT

The present disclosure provides a cleaning system including a swimming pool robot and a base station. The swimming pool robot includes: a body; a first filtering box provided in the body; and at least one debris discharge opening configured to allow debris in the first filtering box to be discharged from the swimming pool robot. The base station includes: a second filtering box; and at least one debris inlet communicating with the second filtering box. When the swimming pool robot returns to the base station, the debris inlet communicates with the debris discharge opening. The second filtering box is at least partially located below a water surface of a swimming pool. The debris in the first filtering box enters the second filtering box through the debris discharge opening and the debris inlet under a suction force.

### CROSS-REFERENCE TO RELATED APPLICATIONS

The present disclosure claims priority to International Patent Application No. PCT/CN2024/137628, filed on Dec. 6, 2024 and entitled “CLEANING SYSTEM, CLEANING DEVICE, BASE STATION AND CONTROL METHOD FOR CLEANING SYSTEM”, which is incorporated herein by reference in its entirety.

The present disclosure claims priority to International Patent Application No. PCT/CN2025/073739, filed on Jan. 21, 2025 and entitled “CLEANING SYSTEM”, which is incorporated herein by reference in its entirety.

The present disclosure claims priority to International Patent Application No. PCT/CN2025/073171, filed on Jan. 19, 2025 and entitled “CLEANING SYSTEM”, which is incorporated herein by reference in its entirety.

### TECHNICAL FIELD

The present disclosure relates to the cleaning technical field, and in particular to, a cleaning system.

### BACKGROUND

When a first filtering assembly of an existing swimming pool robot needs to be cleaned, a user needs to lift the swimming pool robot out of water and manually clean the first filtering assembly, leading to a complicated cleaning process and operation inconvenience.

### SUMMARY

The present disclosure provides a cleaning system including a swimming pool robot and a base station. The swimming pool robot is configured to at least clean liquid in a swimming pool and includes: a body; a first filtering box at least partially provided in the body and configured to filter liquid entering the first filtering box; and at least one debris discharge opening configured to at least allow debris in the first filtering box to be discharged from the swimming pool robot. The base station includes: a second filtering box configured to filter liquid entering the second filtering box; and at least one debris inlet communicating with the second filtering box. When the swimming pool robot returns to the base station in the swimming pool, the debris inlet communicates with the debris discharge opening. The second filtering box is at least partially located below a water surface of the swimming pool. The debris in the first filtering box enters the second filtering box through the debris discharge opening and the debris inlet under a suction force.

### BRIEF DESCRIPTION OF THE DRAWINGS

To illustrate the technical solutions in embodiments of the present disclosure more clearly, the following briefly introduces the accompanying drawings needed for describing the embodiments. It is clear that the accompanying drawings in the following descriptions are merely some embodiments of the present disclosure, and a person of ordinary skill in the art may further obtain other accompanying drawings from these accompanying drawings without creative efforts.

FIG. 1 is a first sectional diagram of a cleaning device according to an embodiment of the present disclosure;

FIG. 2 is a schematic structural diagram of a base station according to an embodiment of the present disclosure;

FIG. 3 is a schematic structural diagram of the base station in FIG. 2 after a second upper cover is exploded;

FIG. 4 is a partial schematic structural diagram of the base station in FIG. 2;

FIG. 5 is a partial schematic structural diagram of the base station in FIG. 2;

FIG. 6 is a bottom diagram of a structure of the base station in FIG. 2;

FIG. 7 is a schematic structural diagram after a cleaning device returns to the base station in FIG. 2 according to an embodiment;

FIG. 8 is a sectional diagram of the base station in FIG. 2;

FIG. 9 is a schematic structural diagram of a cleaning device according to the present disclosure;

FIG. 10 is a schematic diagram of a cleaning device after some components are removed according to the present disclosure;

FIG. 11 is a schematic structural diagram of a lateral section of a cleaning device according to the present disclosure;

FIG. 12 is a schematic structural diagram of a longitudinal section of a cleaning device according to the present disclosure;

FIG. 13 is a schematic diagram of a state in a process in which a cleaning device is docked with a base station according to the present disclosure;

FIG. 14 is a schematic diagram of a state in which a cleaning device moves on a water surface along an edge to return to a base station according to the present disclosure;

FIG. 15 is a schematic structural diagram of a base station (also referred to as a carrying assembly) according to the present disclosure;

FIG. 16 is a schematic structural diagram of a transition seat of a base station according to the present disclosure;

FIG. 17 is an exploded diagram of a carrying member, a transition seat, a support member, and a second filtering box of a base station according to the present disclosure;

FIG. 18 is a sectional diagram of a partial structure after a cleaning device is docked with a base station according to the present disclosure;

FIG. 19 is a schematic diagram showing that a cleaning device searches for a wall on a bottom wall of a swimming pool according to the present disclosure;

FIG. 20 is a schematic diagram showing that a cleaning device moves upward on a fourth wall according to the present disclosure;

FIG. 21 is a schematic diagram of a state in which a cleaning device returns to a base station along an edge of a water surface according to the present disclosure;

FIG. 22 is a schematic diagram showing that a front portion of a cleaning device collides with a first side surface of a support member according to the present disclosure;

FIG. 23 is a schematic diagram of a state after a cleaning device is docked with a base station according to the present disclosure;

FIG. 24 is a schematic diagram after a cleaning device is docked with a base station according to the present disclosure;

FIG. 25 is a schematic diagram of a process in which a cleaning device returns to a base station according to an embodiment of the present disclosure;

FIG. 26 is a schematic diagram of a process in which a cleaning device returns to a base station according to an embodiment of the present disclosure;

FIG. 27 is a schematic diagram of a process in which a cleaning device returns to a base station according to an embodiment of the present disclosure;

FIG. 28 is a schematic diagram of a process in which a cleaning device returns to a base station according to an embodiment of the present disclosure;

FIG. 29 is a schematic diagram of a process in which a cleaning device returns to a base station according to an embodiment of the present disclosure;

FIG. 30 is a schematic diagram of a process in which a cleaning device returns to a base station according to an embodiment of the present disclosure;

FIG. 31 is a schematic diagram of a process in which a cleaning device returns to a base station according to an embodiment of the present disclosure;

FIG. 32 is a schematic diagram of a process in which a cleaning device returns to a base station according to an embodiment of the present disclosure; and

FIG. 33 is a schematic diagram of a process in which a cleaning device returns to a base station according to an embodiment of the present disclosure.

### DETAILED DESCRIPTION

The following clearly and completely describes the technical solutions in embodiments of the present disclosure with reference to the accompanying drawings in embodiments of the present disclosure. It is clear that the described embodiments are merely some but not all of embodiments of the present disclosure. All other embodiments obtained by a person of ordinary skill in the art based on embodiments of the present disclosure without creative efforts shall fall within the protection scope of the present disclosure.

An inventive concept of this application is: A base station is disposed on a poolside, a second filtering assembly is provided on the base station, and the second filtering assembly is at least partially located under a water surface. In other words, a second filtering box of the second filtering assembly is not located on the poolside, but is located in the swimming pool. When a first filtering box of a first filtering assembly of a swimming pool robot needs to be cleaned, the swimming pool robot automatically moves back to the base station in the swimming pool, and the swimming pool robot remains in the swimming pool. Then, the base station transfers debris from the first filtering assembly of the swimming pool robot to the second filtering assembly of the base station, so that the first filtering assembly of the swimming pool robot is cleaned without a manual operation of a user. In this way, the first filtering box can be cleaned more efficiently. The following describes in detail specific content of a swimming pool robot and a base station of a cleaning system by using specific embodiments.

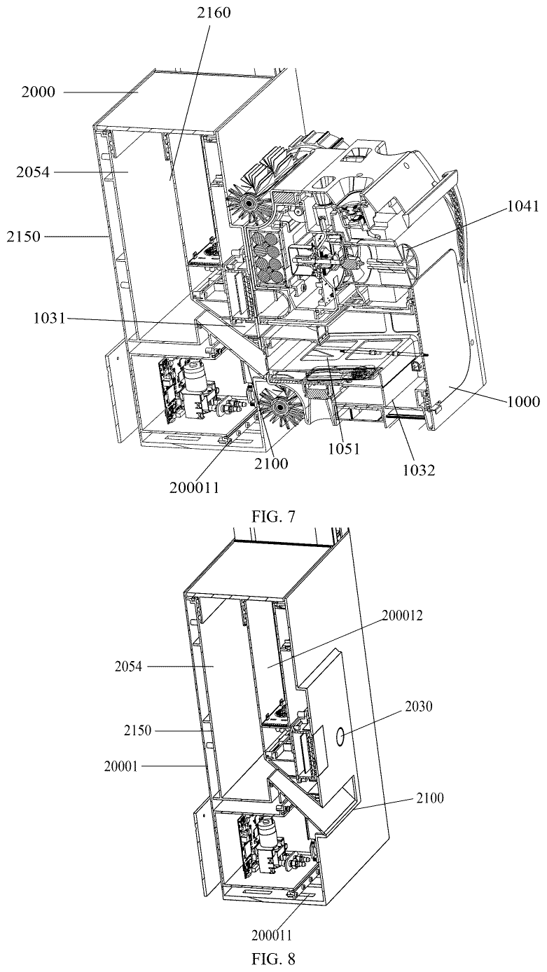

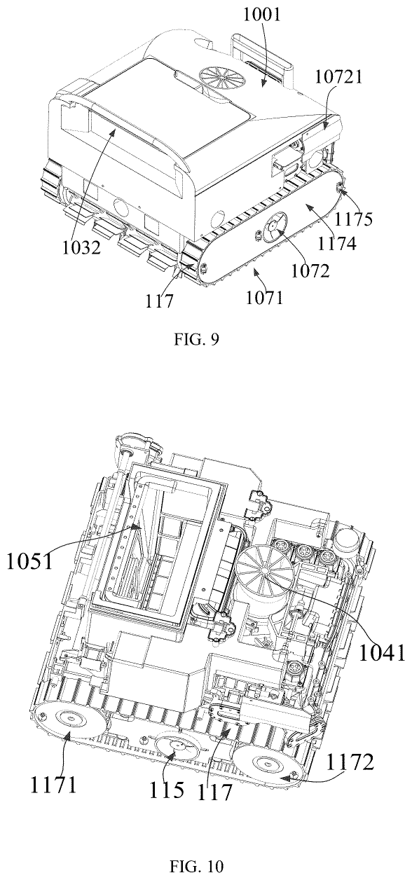

As shown in FIG. 7, the present disclosure provides a cleaning system 1. The cleaning system 1 includes a swimming pool robot 1000 and a base station 2000. The swimming pool robot 1000 is configured to at least perform a cleaning task in a target region. The target region may be, but is not limited to, a swimming pool, a pool, an oil well, a sewer, or the like. An example in which the target region is a swimming pool is used for description in the following. The swimming pool robot 1000 can operate in water of the swimming pool, and the swimming pool robot 1000 can move on at least one of a water surface of the swimming pool, a bottom of the swimming pool, or a wall of the swimming pool. In the following embodiments, a bottom wall of the swimming pool is referred to as a pool bottom for short, a side wall of the swimming pool may be expressed as a pool wall or a wall, and an inner wall of the swimming pool includes the pool bottom and the pool wall.

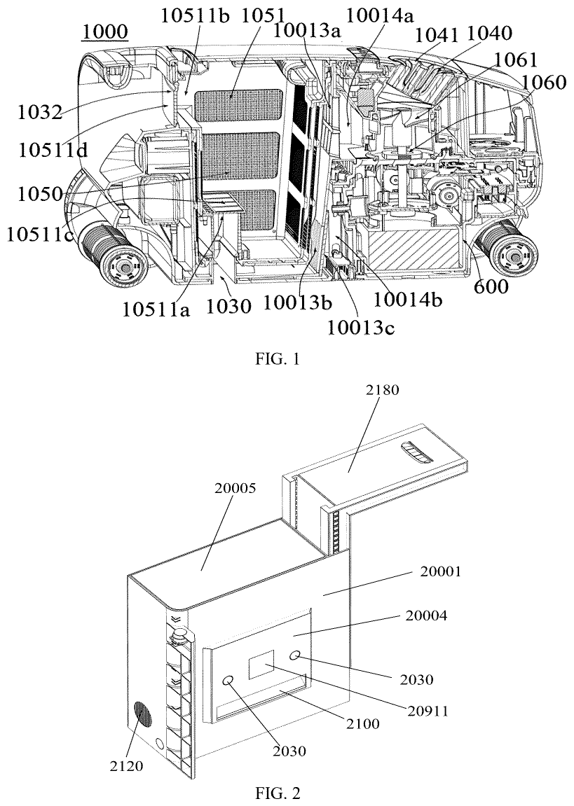

In some embodiments, with reference to FIG. 1, the swimming pool robot 1000 includes a body 1001. The body 1001 is provided with at least one first filtering assembly 1050, at least one suction assembly 1060, at least one liquid inlet portion 1030, at least one liquid outlet portion 1040, a moving mechanism, and a propulsion mechanism.

The liquid inlet portion 1030 is configured to allow liquid to enter the body 1001. The liquid inlet portion 1030 may be provided on a bottom and/or side portion of the body. The liquid outlet portion 1040 is configured to allow liquid in the body 1001 to be discharged. For example, there is one or more liquid outlet portions, and the at least one liquid outlet portion is at least partially provided on a top of the body. The at least one first filtering assembly 1050 is provided inside the body 1001, and the first filtering assembly 1050 is configured to filter debris-loaded water. The debris-loaded water refers to water carrying debris or suspended substances. The at least one suction assembly 1060 is provided inside the body 1001. The suction assembly 1060 is configured to generate a suction force to guide water in the swimming pool to enter the at least one first filtering assembly 1050 through the liquid inlet portion 1030 and be filtered by the first filtering assembly. Filtered liquid flows through an impeller (mentioned below) of the suction assembly and the liquid outlet portion 1040 and then is discharged from the body, and debris in the water remains in the first filtering assembly, so that at least one of the bottom, the wall, the water surface, or a waterline of the swimming pool is cleaned.

In some embodiments, the liquid inlet portion 1030 includes at least one first water inlet 1031 provided on the body 1001.

The liquid outlet portion 1040 includes at least one first water outlet 1041 at least partially provided on the top of the body 1001. For example, the first water outlet is at least partially provided on the top of the body and at least partially provided on a side portion of the body, or the first water outlet is provided on the top of the body. Alternatively, there are a plurality of first water outlets, at least one first water outlet is provided on the top of the body, and at least one first water outlet is at least partially provided on the top of the body and at least partially provided on the side portion of the body.

For example, as shown in FIG. 1 or FIG. 12, the first water inlet 1031 is provided on the bottom of the body 1001, and the first water inlet 1031, the first filtering assembly 1050, the impeller of the suction assembly 1060, and the first water outlet 1041 are sequentially in fluid communication to form a first water flow path for cleaning the pool bottom, the pool wall, or the waterline.

Alternatively, in some embodiments, the liquid inlet portion includes at least one second water inlet 1032. The second water inlet 1032 is provided on a front portion or a rear portion of the body. The second water inlet 1032, the first filtering assembly 1050, the suction assembly 1060, and the first water outlet 1041 are sequentially in fluid communication to form a second water flow path for cleaning the water surface and the waterline of the swimming pool.

In one embodiment, as shown in FIG. 1, the second water inlet 1032 is provided on a front side wall of the front portion of the body. When the swimming pool robot cleans the water surface, the swimming pool robot moves forward to clean the water surface. In another embodiment, as shown in FIG. 12, the second water inlet 1032 is provided on a rear side wall of the rear portion of the body. When the swimming pool robot cleans the water surface, the swimming pool robot moves backward to clean the water surface.

In some embodiments, the suction assembly 1060 includes a main water pump 1061. The main water pump 1061 includes a main motor and an impeller. The main motor is configured to drive the impeller to rotate to generate a suction force in the body.

In some embodiments, the first filtering assembly includes a first filtering box 1051. The first filtering box has at least one filtering surface and is configured to filter liquid entering the first filtering box.

In some embodiments, as shown in FIG. 12, the first filtering box is provided with a first inlet 10511a and a second inlet 10511b. The first inlet 10511a communicates with the first water inlet 1031, so that liquid enters the first filtering box 1051 through the first water inlet 1031 and then is filtered. The second inlet 10511b communicates with the second water inlet 1032, so that liquid enters the first filtering box 1051 through the second water inlet 1032 and then is filtered.

Further, in some embodiments, a first baffle plate 10511c is provided at the first water inlet 1031 and/or at the first inlet 10511a. When the swimming pool robot cleans the pool bottom or the pool wall, the first baffle plate is opened to expose the first inlet or the first water inlet, enabling the liquid in the swimming pool to enter the first filtering box through the first water inlet and the first inlet. Further, a second baffle plate 10511d is provided at the second water inlet and/or at the second inlet 10511b. When the swimming pool robot cleans the water surface, the second baffle plate is opened to expose the second inlet or the second water inlet, enabling the liquid to enter the first filtering box through the second water inlet and the second inlet, and the first baffle plate is closed to cover the first water inlet or the first inlet.

In some embodiments, the swimming pool robot includes a self-cleaning debris discharge opening 1300 (namely, a debris discharge opening) configured to allow debris in the first filtering box to be discharged from the swimming pool robot. Correspondingly, the base station includes a self-cleaning debris inlet (namely, a debris inlet) configured to allow the debris in the first filtering box to enter. When the swimming pool robot returns to the base station, and the debris discharge opening communicates with the debris inlet, the debris in the first filtering box enters a second filtering box of a second filtering assembly through the debris discharge opening and the debris inlet under a suction force of a power assembly (mentioned below).

In some embodiments, the second water inlet serves as the debris discharge opening, the first water inlet serves as the debris discharge opening, or the debris discharge opening may be an opening provided on the swimming pool robot independently of the first water inlet and the second water inlet. For example, the debris discharge opening is provided on the bottom of the swimming pool robot and communicates with the first filtering box, and the swimming pool robot further includes a cover plate. The cover plate is configured to be opened to expose the debris discharge opening or be closed to cover the debris discharge opening. When the swimming pool robot performs cleaning in the swimming pool, or the swimming pool robot is on a poolside, and a user does not operate the cover plate, the cover plate remains closed to cover the debris discharge opening to prevent the debris in the first filtering box from falling out through the debris discharge opening. Only when the swimming pool robot returns to the base station, and the base station needs to clean the first filtering box, the cover plate is opened to expose the debris discharge opening, so that the debris discharge opening communicates with the debris inlet, and the debris in the first filtering box is sucked into the second filtering box.

For example, the first filtering box includes a third opening. The third opening is at least partially provided on a bottom of the first filtering box and configured to allow the debris in the first filtering box to be discharged. The body is provided with a seventh opening. The seventh opening corresponds to the third opening. If the seventh opening is lower than the third opening, the seventh opening is the debris discharge opening. If the seventh opening is higher than the third opening, the third opening is the debris discharge opening.

Further, in some embodiments, if the third opening is the debris discharge opening, the third opening is a bottom opening of the first filtering box, the cover plate is a first bottom plate, the first bottom plate is closed to cover the bottom opening or is opened to expose the bottom opening, and the first inlet is provided on the first bottom plate. Alternatively, in another embodiment, the third opening is a sixth opening at the bottom of the first filtering box, the sixth opening and the first inlet are arranged on the bottom of the first filtering box in a staggered manner, and the cover plate is a fifth baffle plate. Alternatively, if the seventh opening is the debris discharge opening, the cover plate is a second cover plate.

In some embodiments, the body is provided with a top opening (namely, a putting-in and taking-out opening) configured to allow the first filtering box to be put in or taken out from a first accommodating cavity.

In some embodiments, the swimming pool robot further includes a self-cleaning water inlet (namely, a cleaning water inlet) configured to allow cleaning water to enter the first filtering box of the swimming pool robot to clean the first filtering box. In some embodiments, the cleaning water inlet may be the first water inlet, the second water inlet, the first water outlet, or the putting-in and taking-out opening, or the cleaning water inlet may be an opening provided on the body independently of the first water inlet, the second water inlet, the first water outlet, and the putting-in and taking-out opening, and the cleaning water inlet is in in fluid communication with the first filtering box.

In some embodiments, the swimming pool robot includes a moving mechanism and a propulsion mechanism. The moving mechanism is configured to at least drive the swimming pool robot to move on the pool bottom and the pool wall. The propulsion mechanism is configured to at least drive the swimming pool robot to move on the water surface.

For example, the moving mechanism 1071 includes a first moving wheel 1171, a second moving wheel 1172, and a track 117 wrapped around peripheries of the first moving wheel and the second moving wheel. An annular region 1173 is formed between an inner side wall of the track and the two moving wheels. For example, there are two moving mechanisms, and the two moving mechanisms are symmetrically provided on two side portions of the body. In some embodiments, the moving mechanism further includes an outer cover plate 1174. The outer cover plate is provided on the body and blocks the first moving wheel and the second moving wheel to prevent the moving wheels from being exposed, to protect the moving wheels.

For example, the propulsion mechanism 1072 may include at least one first propeller 10721 configured to generate a first thrust to push the swimming pool robot to move on the water surface, that is, to push the swimming pool robot to move forward, move backward, and make a turn on the water surface. For example, there are two first propellers 10721 symmetrically provided on two sides of the swimming pool robot, and the second water inlet 1032 and one first propeller 10721 are provided on the front portion of the body, and the other first propeller is provided on the rear portion of the body, to generate a thrust for the swimming pool robot to move on the water surface.

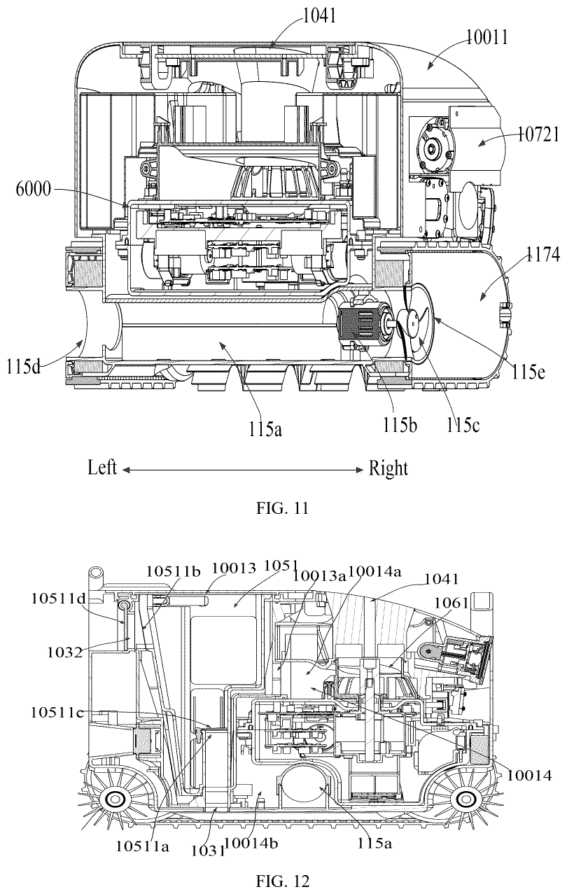

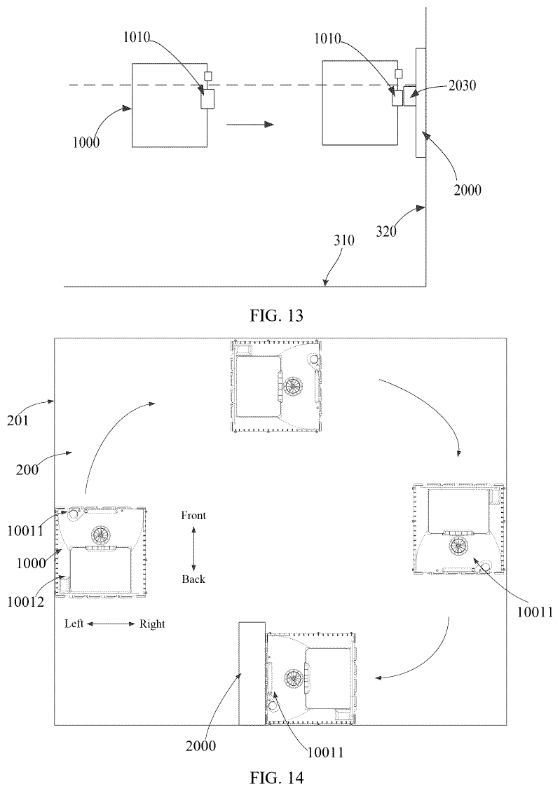

Further, in some embodiments, as shown in FIG. 10 and FIG. 11, the propulsion mechanism further includes a lateral propulsion assembly 115. The lateral propulsion assembly includes a lateral flow channel 115a, a lateral impeller 115c, and a lateral motor 115b that drives the lateral impeller 115c to rotate. Ports at two ends of the lateral flow channel 115a respectively serve as a fluid inlet and a fluid ejection outlet. Liquid enters the lateral propulsion assembly through the fluid inlet, and the liquid is ejected through the fluid ejection outlet in a direction away from a side portion of the body 1001 of the swimming pool robot. The ejected water applies a second thrust to the swimming pool robot. The second thrust may at least provide a thrust component in a lateral direction of the swimming pool robot for the swimming pool robot, enabling the swimming pool robot to be attached to or be close to the pool wall when the swimming pool robot moves on the water surface or the pool bottom along an edge and enabling the swimming pool robot to laterally move on the pool wall along the waterline to clean the waterline.

For example, the lateral flow channel is at least partially provided in an annular region 1173 of one moving mechanism. The fluid ejection outlet is provided on the outer cover plate of the moving mechanism, enabling the lateral flow channel to communicate with the outside, or an opening is provided on the outer cover plate, enabling the fluid ejection outlet to communicate with the opening on the outer cover plate, so that the lateral flow channel communicates with the outside. For example, the opening on the outer cover plate is an avoidance hole or an avoidance grill, that is, a grill is provided in the opening, to prevent large debris in the swimming pool from entering the lateral flow channel, so that rotation of the lateral impeller is not affected. Alternatively, each of the two ends of the lateral flow channel is located in an annular region of one moving mechanism without occupying other regions on the body of the swimming pool robot, and each of the fluid inlet and the fluid ejection outlet is located on an outer cover plate of one moving mechanism, so that the lateral flow channel laterally runs through the side portions of the body, so that the swimming pool robot has a lateral propulsion function with a more compact structure.

In some embodiments, the swimming pool robot further includes a floating-submerging mechanism configured to drive the swimming pool robot to be switched between a position on the pool bottom and a position on the water surface. For example, the floating-submerging mechanism includes a buoyancy cavity, a pump, and an air inlet. The pump communicates with the buoyancy cavity, and the air inlet communicates with the buoyancy cavity or the pump. When the swimming pool robot moves from the pool bottom to the pool wall and then moves to the waterline on the pool wall, the air inlet is exposed above the water surface, that is, the air inlet is located in air, and external gas enters the buoyancy cavity through the air inlet under the pump to increase a volume of gas in the buoyancy cavity, so that the swimming pool robot can float up to the water surface. Alternatively, the swimming pool robot further includes a propeller. The swimming pool robot directly rises from the pool bottom to the water surface under the propeller, so that the air inlet is exposed above the water surface. Then, external gas enters the buoyancy cavity under the pump to increase a volume of gas in the buoyancy cavity, so that the swimming pool robot floats on the water surface. In contrast, the gas in the buoyancy cavity is discharged under the pump, so that the swimming pool robot can be switched from a position on the water surface to a position on the pool wall, or the swimming pool robot can be directly switched from a position on the water surface to a position on the pool bottom without being switched to a position on the pool wall.

In some embodiments, the body includes a first accommodating cavity 10013 and a second accommodating cavity 10014. The first filtering box 1051 is provided in the first accommodating cavity. The second accommodating cavity includes a first cavity 10014a and a second cavity 10014b. The first cavity is separated from the second cavity. A second liquid discharge opening 10013a is provided on a side wall of the first accommodating cavity, enabling the first accommodating cavity to communicate with the first cavity. The first water outlet 1041 is provided on the body of the swimming pool robot and communicates with the first cavity. The impeller of the main water pump is provided in the first cavity 10014a, and the main motor of the main water pump is provided in the second cavity 10014b, so that the water inlet, the first filtering box, the second liquid discharge opening, the first cavity, and the first water outlet on the body sequentially communicate to form the first water flow path of the swimming pool robot.

For example, a first filtering box cavity is provided in the body. An inner cavity of the first filtering box cavity serves as the first accommodating cavity, the first filtering box 1051 is provided in the first filtering box cavity, and the second liquid discharge opening is provided on the first filtering box cavity, enabling the first accommodating cavity to communicate with the first cavity.

In the above embodiments, the swimming pool robot is mainly briefly described, and in the following embodiments, a specific structure of the base station is described.

In some embodiments, as shown in FIG. 2 or FIG. 17 and FIG. 18, the base station 2000 includes a base station body 20001, a second filtering assembly 2110, and a power assembly. When the swimming pool robot berths at the base station, the first filtering assembly 1050 is in fluid communication with the second filtering assembly 2110, and the power assembly 2170 is configured to generate a suction force, enabling water to flow from the first filtering assembly 1050 to the second filtering assembly 2110. The power assembly is provided downstream of the second filtering assembly.

In some embodiments, the base station body 20001 includes a support member 2050, or the support member 2050 is the base station body. A third accommodating cavity 2054 is provided in the base station body 20001. The second filtering assembly 2110 is at least partially provided in the third accommodating cavity 2054. The third accommodating cavity 2054 or the base station body is provided with the debris inlet 2100. The swimming pool robot is provided with the debris discharge opening 1300. When the swimming pool robot returns to the base station 2000, the debris discharge opening 1300 of the swimming pool robot is docked with the debris inlet 2100 of the base station 2000. Then, under the power assembly, the liquid in the swimming pool is sucked into the first filtering box through the cleaning water inlet, and the debris or the debris-loaded water in the first filtering box 1051 is sucked into the second filtering assembly 2110 through the debris discharge opening and the debris inlet. The debris remains in the second filtering assembly 2110 after being filtered out by the second filtering assembly 2110, and the filtered water is discharged through a self-cleaning water discharge opening 2120 (namely, a water discharge opening) on the base station body 20001, so that the first filtering box 1051 of the swimming pool robot is cleaned. In other words, the cleaning water inlet, the first filtering assembly, the debris discharge opening, the debris inlet, the second filtering assembly 2110, the power assembly 2170, and the water discharge opening 2120 are sequentially in fluid communication to form a third water flow path for cleaning the first filtering box. In some embodiments, the power assembly includes a base station water pump.

In some embodiments, the debris in the first filtering box of the swimming pool robot is transferred to or collected into the second filtering box of the base station under the power assembly, and during this process, the liquid in the swimming pool enters the first filtering box through the cleaning water inlet to carry the debris in the first filtering box to the second filtering box, and the liquid filtered by the second filtering box returns to the swimming pool. In other words, the water used by the base station to clean the first filtering box needs to circulate in the swimming pool, and each of the cleaning water inlet, the debris discharge opening, and debris inlet is at least partially located below the water surface to ensure that the liquid in the swimming pool can flow through the third water flow path for cleaning the first filtering box and then circulate in the swimming pool.

For example, the first filtering box is at least partially located below the water surface, so that the debris discharge opening is located below the water surface, and when the swimming pool robot returns to the base station, the first filtering box is at least partially located below the water surface, so that the debris discharge opening is located below the water surface. Alternatively, the debris inlet is located below the water surface. Alternatively, in some embodiments, the water discharge opening is located below the water surface, so that the liquid in the swimming pool can flow through the third water flow path and then circulate in the swimming pool more easily.

In some embodiments, when the debris inlet 2100 is provided on a side wall of the third accommodating cavity 2054, the side wall, of the third accommodating cavity 2054, on which the debris inlet 2100 is provided is expressed as a first docking surface 20004 for ease of description, or a side wall, of the base station body, on which the debris inlet 2100 is provided is expressed as a first docking surface 20004.

In one embodiment, as shown in FIG. 6, FIG. 7, and FIG. 8, the debris inlet 2100 is provided on a side wall of the third accommodating cavity 2054, and the debris discharge opening 1300 of the swimming pool robot is provided on the bottom of the swimming pool robot. The debris discharge opening 1300 may be the first water inlet 1031, or the debris discharge opening 1300 may be an opening independently provided on the swimming pool robot or the first filtering box 1051. The debris discharge opening 1300 may be the putting-in and taking-out opening.

When the swimming pool robot returns to the base station 2000, an overall direction of the swimming pool robot is substantially parallel to the first docking surface 20004, and the swimming pool robot is substantially in a vertical posture. For example, the debris discharge opening is provided on the bottom of the swimming pool robot. The bottom of the base station body is higher than the bottom wall of the swimming pool, and the base station body is located in the swimming pool. The debris inlet 2100 may be provided on a front side wall, a left side wall, a right side wall, the bottom, or the top of the base station body, and correspondingly, the first docking surface 20004 may be the front side wall, the left side wall, the right side wall, a bottom surface, or a top surface of the base station body. The debris discharge opening 1300 is provided on the bottom of the swimming pool robot, and the debris inlet 2100 is provided on the front side wall (as the first docking surface) of the base station body.

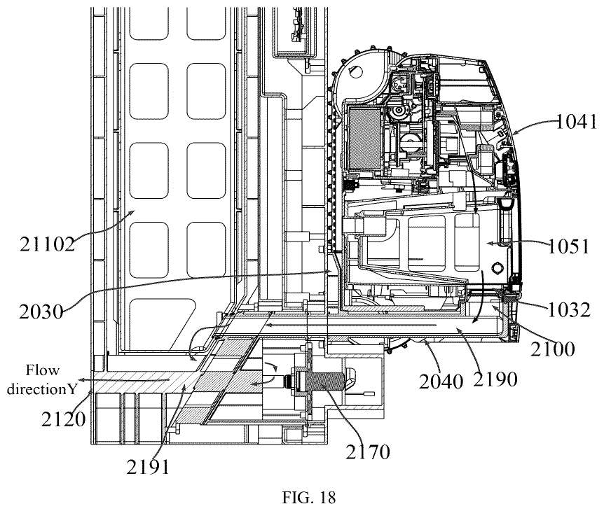

Alternatively, in other embodiments, the debris inlet 2100 is provided on a side wall of the third accommodating cavity 2054 or a side wall of the base station body, and the debris discharge opening 1300 is provided on a side wall of the swimming pool robot and is not provided on the bottom of the swimming pool robot. For example, as shown in FIG. 18, the second water inlet 1032 serves as the debris discharge opening 1300, or the debris discharge opening 1300 is provided on a side wall of the swimming pool robot. For example, when the second water inlet is provided on the front side wall of the front portion of the swimming pool robot and does not serve as the debris discharge opening 1300, the debris discharge opening 1300 may be provided on the rear side wall of the rear portion of the swimming pool robot or on the front side wall of the front portion of the swimming pool robot, but avoid the second water inlet. For example, the debris discharge opening 1300 and the second water inlet are both provided on the front side wall of the front portion of the swimming pool robot, and the debris discharge opening 1300 is located below the second water inlet. When the swimming pool robot returns to the base station 2000, the front portion of the swimming pool robot is docked with a side wall of the base station, the overall direction of the swimming pool robot is substantially perpendicular to the first docking surface, and the swimming pool robot is substantially in a horizontal state. Alternatively, the debris discharge opening 1300 is provided on a left side wall or a right side wall of the swimming pool robot. When the swimming pool robot returns to the base station 2000, the side wall of the swimming pool robot is docked with the side wall of the base station body, the overall direction of the swimming pool robot is substantially parallel to the first docking surface, and the swimming pool robot is substantially in a vertical state.

Alternatively, if the debris inlet 2100 is provided on the top of the third accommodating cavity 2054 or the top of the base station body, when the swimming pool robot returns to the base station 2000, the swimming pool robot is located on the top of the third accommodating cavity 2054 or the top of the base station body, the swimming pool robot is substantially in a horizontal posture, the debris discharge opening 1300 on the bottom of the swimming pool robot is docked with the debris inlet 2100 of the base station 2000, and the swimming pool robot is located on the top of the base station body 20001.

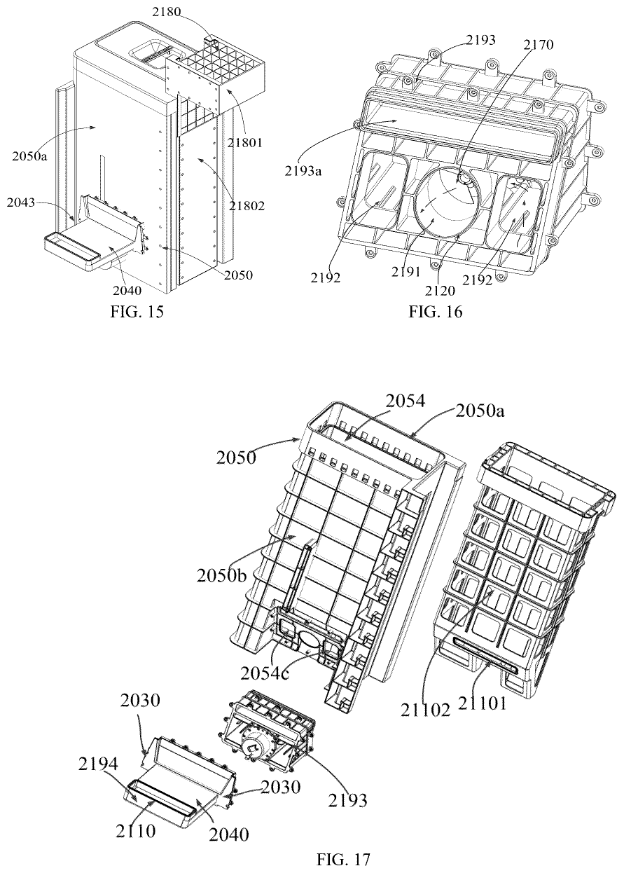

In some embodiments, as shown in FIG. 15, the base station includes a carrying member 2040. The carrying member 2040 is provided with the debris inlet 2100. The carrying member is provided on a lower portion of the base station body. The carrying member protrudes from the base station body.

For example, a first end of the carrying member 2040 is fixed to the support member 2050, a second end of the carrying member substantially extends outward in a horizontal direction, and a top surface of the carrying member 2040 is provided with a carrying surface 2043. The second end of the carrying member is provided with the debris inlet 2100, and a second docking assembly 2030 (mentioned below) is provided at the first end or on the carrying surface.

The carrying member may always remain fixed to the support member 2050, or the carrying member may be in an operation posture before the swimming pool robot returns to the base station, and the carrying member 2040 is in a retracted posture after the swimming pool robot leaves the base station. When the carrying member 2040 is in the retracted posture, the carrying member 2040 remains substantially parallel to a side wall (referred to as a first side surface 2050a for ease of description) of the support member 2050, and when the carrying member 2040 is in the operation posture, the carrying member 2040 remains substantially perpendicular to the first side surface 2050a of the support member 2050. Alternatively, when the carrying member is in the retracted state, the carrying member is retracted into the support member 2050, and when the carrying member is in the operation state, the carrying member extends out of the support member. In other words, regardless of whether the carrying member has two states, when the swimming pool robot returns to the base station, the carrying member protrudes from the base station body to carry the robot.

For example, if the first water inlet 1031 of the swimming pool robot serves as the debris discharge opening, and the bottom of the swimming pool robot is docked with the carrying member of the base station, both the first water inlet 1031 and a first docking assembly are provided on the bottom of the swimming pool robot, and when the swimming pool robot is docked with the base station, the bottom of the swimming pool robot is located on the carrying surface. If the second water inlet of the swimming pool robot serves as the self-cleaning debris discharge opening, when the second water inlet is provided on a front side surface of the front portion of the swimming pool robot, the front portion of the swimming pool robot is docked with the carrying member of the base station, and correspondingly, the first docking assembly is provided on the front portion of the swimming pool robot. As shown in FIG. 12, when the second water inlet is provided on a rear side surface of the rear portion of the swimming pool robot, the rear portion of the swimming pool robot is docked with the carrying member of the base station, and correspondingly, the first docking assembly is provided on the rear portion of the swimming pool robot.

In some embodiments, as shown in FIG. 16 and FIG. 18, the carrying member is provided with a first flow channel 2190, enabling the debris inlet to communicate with the interior of the second filtering assembly. As shown in FIG. 17, to enable the debris inlet on the carrying member to be docked with the debris discharge opening, an extension portion 2194 protruding upward is disposed on an end of the first flow channel, and a port of the extension portion serves as the debris inlet 2100. When the swimming pool robot is docked with the base station, the extension portion 2194 extends to the debris discharge opening and is docked with the debris discharge opening, so that the liquid in the first filtering box enters the first flow channel 2190 through the debris discharge opening and the debris inlet 2100 under suction of the power assembly 2170.

In some embodiments, as shown in FIG. 17, the second filtering box is provided with at least one third inlet 21101 communicating with the interior of the second filtering box. The third inlet 21101 communicates with the first flow channel 2190. The third accommodating cavity 2054 is provided with at least one fourth outlet 2054c. As shown in FIG. 16, the support member is further provided with a second flow channel 2191 (namely, a liquid discharge channel). The power assembly 2170 is at least partially disposed in the second flow channel. A first end of the second flow channel communicates with the fourth outlet, and a second end of the second flow channel serves as the water discharge opening 2120. Under the power assembly, the water enters the first filtering box through the cleaning water inlet, the debris-loaded water in the first filtering box flows through the debris discharge opening, the debris inlet, the first flow channel, the second filtering box, and the second flow channel, the debris remains in the second filtering assembly, and the liquid is discharged through the water discharge opening. For example, as shown in FIG. 18, the cleaning water inlet is the first water outlet, and the liquid in the swimming pool enters the first cavity through the first water outlet, then enters the first accommodating cavity through the second liquid discharge opening, then flows into the first filtering box, and then sequentially flows through the debris discharge opening, the debris inlet, the first flow channel, the second filtering box, and the second flow channel, and the filtered liquid is finally discharged through the water discharge opening. A flow direction Y is indicated by an arrow in FIG. 18.

Alternatively, as a variant, the power assembly is not provided on the base station and is provided on the swimming pool robot, that is, the power assembly is the suction assembly. When the suction assembly rotates forward, the swimming pool robot performs the cleaning task, and when the suction assembly rotates reversely, the liquid in the swimming pool is sucked into the first filtering box through the first water outlet to form the flow direction Y, so that the first filtering box is cleaned.

In some embodiments, as shown in FIG. 16 and FIG. 18, the base station is further provided with at least one transition flow channel 2192. One end of the transition flow channel communicates with the fourth outlet 2054c, and the other end of the transition flow channel communicates with a second flow channel, so that the filtered liquid is discharged from the base station through the transition flow channel and the second flow channel. In one embodiment, when flowing from the transition flow channel to the second flow channel, the liquid needs to make a turn before the liquid enters the second flow channel, so that the transition flow channel and the second flow channel occupy less space of the support member 2050 in a height direction, and there is more space of the support member in the height direction to accommodate the second filtering box. A flow direction of the liquid in the second flow channel is opposite to that in the transition flow channel, and the flow direction of the liquid is similar to an S-shaped direction, leading to a compact structure of the base station. In one embodiment, both the second flow channel and the transition flow channel are located below the second filtering box. In other words, the liquid in the first filtering box sequentially flows through the debris discharge opening, the debris inlet, the first flow channel, the second filtering box, the transition flow channel, the second flow channel, and the water discharge opening to form the third water flow path for self-cleaning.

In some embodiments, as shown in FIG. 16 and FIG. 17, the base station further includes a transition seat 2193. The transition seat is disposed between the carrying member 2040 and the support member 2050. The transition seat is provided with a first communicating opening 2193a configured to allow the first flow channel to communicate with the interior of the second filtering assembly. At least one transition flow channel 2192 and at least one second flow channel 2191 are provided on the transition seat in a staggered manner. The transition flow channel 2192 extends from the fourth outlet 2054c to the carrying member, and the second flow channel 2191 extends from the carrying member to the support member. The second flow channel is located below the second filtering assembly 2110 and runs through the support member to communicate with the outside. In other words, a start end of the transition flow channel communicates with the fourth outlet 2054c, a tail end of the transition flow channel communicates with a start end of the second flow channel, and a tail end of the second flow channel communicates with the outside. To form greater suction, the power assembly 2170 is disposed near the start end of the second flow channel. For example, the power assembly includes a water pump, and an impeller of the water pump is disposed near the start end of the second flow channel, so that a suction force can be generated when the impeller rotates. In one embodiment, there are two transition flow channels and one second flow channel. The two transition flow channels are symmetrically disposed on two sides of the second flow channel to expand the second flow channel, so that the liquid filtered by the second filtering assembly can be quickly discharged. Certainly, in another embodiment, the transition flow channel may not be disposed, only the second flow channel may be disposed, and the fourth outlet 2054c directly communicates with the second flow channel.

In some embodiments, as shown in FIG. 15, the base station further includes a fixing seat 2180. The fixing seat 2180 is fixedly connected to a poolside. The second filtering assembly 2110 is at least partially accommodated in the base station body. The carrying member 2040 is connected to the base station body and is configured to be docked with the swimming pool robot operating in the swimming pool. The debris inlet is provided on the carrying member 2040 or the base station body and communicates with the second filtering assembly 2110 through a duct. The power assembly 2170 is configured to provide a suction force for water to at least sequentially flow through the swimming pool robot, the debris inlet, and the second filtering assembly 2110 after the swimming pool robot is docked with the base station. The base station body is movably connected to the fixing seat, so that the carrying member is adjusted to be at least partially located below the water surface of the swimming pool.

For example, the fixing seat is configured to fix the base station as a whole to the poolside or the pool wall, so that the carrying member is located underwater. In one embodiment, the support member is movably provided on the fixing seat in a vertical direction to change a height of the support member on the fixing seat to adapt to swimming pools of different depths.

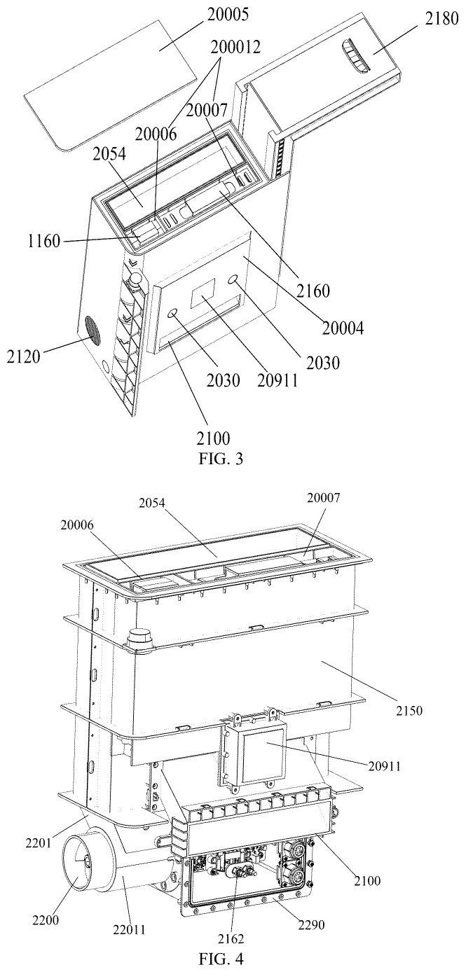

For example, as shown in FIG. 22 or FIG. 3, the fixing seat includes a mounting portion and a fixing portion 21802 connected to the mounting portion 21801. The fixing portion 21802 extends in a height direction of the support member. A plurality of mounting holes are provided on the fixing portion at different heights. Mating members are provided on the support member. The mating members are mounted in the mounting holes at different heights to change a height of the base station on the fixing seat to adapt to swimming pools of different depths. A position of the mating member and a position of the mounting hole may be reversed. In one embodiment, the mounting portion extends horizontally and may be mounted on the poolside. The fixing portion extends vertically, enabling the fixing portion to abut against or be close to the pool wall in the swimming pool. The support member is mounted on the fixing portion.

In some embodiments, a distance between a lowest point of the carrying member and the water surface of the swimming pool is greater than an overall length of the swimming pool robot, so that when the base station is mounted on the poolside, the carrying member can remain underwater, enabling the base station to be docked with the swimming pool robot underwater.

In some embodiments, the second filtering assembly 2110 includes a second filtering box 21102, and the second filtering box is provided with at least one filtering surface. A filtration level of the filtering surface of the second filtering box may be the same as or different than that of the filtering surface of the first filtering box. The filtration level of the filtering surface of the second filtering box is higher than the filtration level of the filtering surface of the first filtering box, and the second filtering box can filter out debris of a smaller size, so that the second filtering box can perform fine filtration, to ensure that all debris discharged from the first filtering box can be collected into the second filtering box. Because the liquid is discharged into the swimming pool through the water discharge opening, the second filtering box performs fine filtration, to prevent the filtered garbage from flowing into the swimming pool with the liquid through the water discharge opening. In this way, a cleaning effect is not affected.

In some specific embodiments, if the first water inlet serves as the debris discharge opening, when the swimming pool robot 1000 cleans the pool bottom or the pool wall, the first baffle plate is opened in a first direction to expose the first water inlet, enabling the liquid to flow into the first filtering assembly 1050. When the base station cleans the first filtering box, the first baffle plate is opened in a second direction, enabling the debris-loaded water in the first filtering box to be discharged through the first water inlet 1031. The first direction is opposite to the second direction.

If the second water inlet serves as the debris discharge opening, when the swimming pool robot 1000 cleans the water surface, the second baffle plate is opened in a third direction to expose the second water inlet, enabling the liquid to flow into the first filtering assembly 1050. When the base station cleans the first filtering box, the second baffle plate is opened in a fourth direction, enabling the debris-loaded water in the first filtering box to be discharged through the second water inlet.

In some embodiments, when the debris discharge opening is provided on the body or the first filtering box independently of the first water inlet and the second water inlet, the swimming pool robot further includes a baffle plate, and the baffle plate is configured to be closed to cover the debris discharge opening or be opened to expose the debris discharge opening. When the swimming pool robot performs cleaning or is on the poolside, the baffle plate remains closed to cover the debris discharge opening. Only when the swimming pool robot returns to the base station, and the first filtering box is cleaned, the baffle plate is opened to expose the debris discharge opening, so that the debris discharge opening is docked with the debris inlet.

That the debris inlet is docked with the debris discharge opening means that the debris inlet is in fluid communication with the debris discharge opening. The debris inlet may directly communicate with the debris discharge opening or indirectly communicate with the debris discharge opening through a duct. The debris inlet may be docked with the debris discharge opening in a sealing manner or through a gap.

In some embodiments, as shown in FIG. 18, the second filtering assembly 2110 includes a second filtering box 21102. The second filtering box 21102 is provided with at least one filtering surface. The second filtering box 21102 is provided with a third inlet 21101. The debris inlet 2100 communicates with the third inlet 21101. Under the power assembly, the debris-loaded water in the first filtering box 1051 enters the second filtering box 21102 through the debris discharge opening 1300, the debris inlet 2100, and the third inlet 21101, and after the debris-loaded water is filtered by the second filtering box 21102, the debris remains in the second filtering box 21102, and the filtered liquid is discharged from the base station 2000 through the water discharge opening 2120.

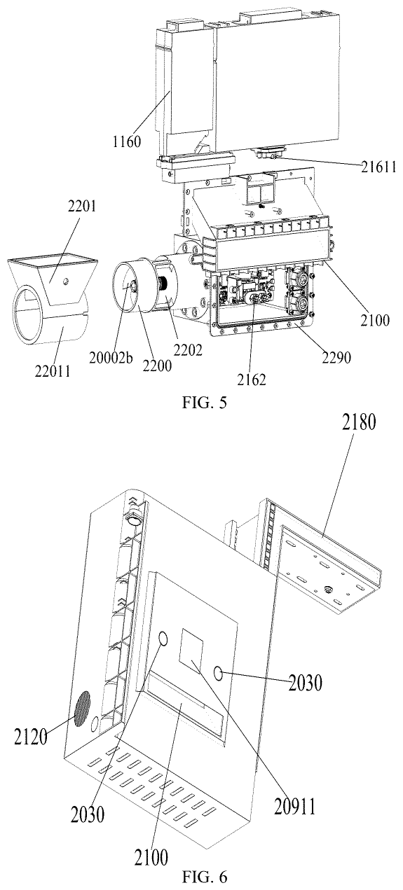

In some embodiments, as shown in FIG. 4 and FIG. 5, the base station body 20001 is further provided with a liquid discharge channel 2200. One end of the liquid discharge channel 2200 communicates with the third accommodating cavity 2054, and the other end of the liquid discharge channel 2200 serves as the water discharge opening 2120. The liquid filtered by the second filtering box 21102 enters a gap between the third accommodating cavity 2054 and the second filtering box 21102 and then enters the liquid discharge channel 2200, and is finally discharged from the base station 2000 through the water discharge opening 2120.

Specifically, to enable the liquid in the third accommodating cavity 2054 to be quickly discharged from the base station 2000 through the liquid discharge channel 2200, the liquid discharge channel 2200 is located below the third accommodating cavity 2054, the liquid discharge channel 2200 is connected to the third accommodating cavity 2054 through a first transition portion 2201, and the third accommodating cavity 2054 communicates with the liquid discharge channel 2200 through a hollow inner cavity of the first transition portion 2201, so that the liquid in the third accommodating cavity 2054 quickly flows into the liquid discharge channel 2200 under gravity and the base station water pump 20002 through the first transition portion 2201, and is finally discharged from the base station 2000 through the self-cleaning water discharge opening 2120.

In one embodiment, as shown in FIG. 4 and FIG. 5, a bottom of the first transition portion 2201 is sleeved on an outer wall of the liquid discharge channel 2200, or the bottom of the first transition portion 2201 is inserted into a side wall of the liquid discharge channel 2200, or the bottom of the first transition portion 2201 is molded onto the liquid discharge channel 2200 or detachably connected to the liquid discharge channel 2200 in another manner, and a top of the first transition portion 2201 may be molded onto a bottom of the third accommodating cavity 2054 or detachably connected to the bottom of the third accommodating cavity 2054.

Specifically, a first connection portion 22011 is provided on the bottom of the first transition portion 2201, and the first connection portion 22011 is sleeved on the outer wall of the liquid discharge channel 2200, so that the first transition portion 2201 is connected to the liquid discharge channel 2200. In addition, a hollow inner cavity of the first connection portion 22011 communicates with the hollow inner cavity of the first transition portion 2201 and the third accommodating cavity 2054, an outer peripheral wall of the liquid discharge channel 2200 is provided with at least one second communicating opening 2202, and the hollow inner cavity of the first connection portion 22011 communicates with the liquid discharge channel 2200 through the second communicating opening 2202, so that the third accommodating cavity 2054, the first transition portion 2201, the first connection portion 22011, and the liquid discharge channel 2200 communicate. For example, the first connection portion 22011 is an annular cylinder. The first connection portion 22011 tapers in a direction from the third accommodating cavity 2054 to the liquid discharge channel 2200, so that the liquid can be gathered in the liquid discharge channel 2200.

In some embodiments, the base station 2000 further includes a first sealed box 2290 having a sealed cavity configured to accommodate a battery pack, a control system of the base station 2000, a second motor 20002a of the base station water pump 20002, and the like.

In some embodiments, as shown in FIG. 7, the base station body 20001 further includes a fourth accommodating cavity 200011. The first sealed box 2290 and the liquid discharge channel 2200 are provided in the fourth accommodating cavity 200011. The second motor 20002a of the base station water pump 20002 is provided in the first sealed box 2290. An output shaft of the second motor extends out of the first sealed box 2290 and extends into the liquid discharge channel 2200 to be connected to a second impeller 20002b of the base station water pump 20002. The second motor 20002a is configured to drive the second impeller 20002b to rotate to form negative pressure in the third accommodating cavity 2054, so that the debris-loaded water in the first filtering box 1051 of the swimming pool robot is sucked into the second filtering box 21102 and then is filtered.

The first sealed box 2290 and the liquid discharge channel 2200 are both provided in the fourth accommodating cavity 200011, and the first sealed box is close to the liquid discharge channel, so that the second motor 20002a can be conveniently provided in the first sealed box 2290, and the output shaft of the second motor 20002a extends out of the first sealed box 2290 and then extends into the liquid discharge channel 2200 to be connected to the second impeller 20002b.

For example, the liquid discharge channel 2200 and the first sealed box 2290 are arranged in the fourth accommodating cavity 200011 in a front-back direction or a left-right direction, and the output shaft of the second motor 20002a extends out of the first sealed box 2290 in the horizontal direction and extends into the liquid discharge channel 2200 in the horizontal direction, so that the second motor 20002a is conveniently connected to the second impeller 20002b.

In some embodiments, the fourth accommodating cavity 200011 is located below the third accommodating cavity 2054, so that the third accommodating cavity 2054 is disposed close to the fourth accommodating cavity 200011. In this way, the liquid in the third accommodating cavity 2054 can quickly flow into the liquid discharge channel 2200 under gravity. Therefore, the liquid in the third accommodating cavity 2054 can be quickly discharged. In other embodiments, the third accommodating cavity 2054 and the fourth accommodating cavity 200011 may alternatively be horizontally arranged in a left-right direction or a front-back direction. This can also shorten a distance between the third accommodating cavity 2054 and the liquid discharge channel 2200.

In some embodiments, as shown in FIG. 3, the base station body 20001 further includes a fifth accommodating cavity and a water quality testing assembly, and/or a second reagent spreading assembly. The water quality testing assembly 1160 and/or the second reagent spreading assembly 2160 are/is provided in the fifth accommodating cavity 200012. In one embodiment, the fifth accommodating cavity 200012 and the third accommodating cavity 2054 are disposed side-by-side and located above the fourth accommodating cavity 200011, leading to compact structural arrangement of the base station body 20001.

For example, the third accommodating cavity 2054 is located behind the fifth accommodating cavity 200012. To enable the debris inlet 2100 of the base station body 20001 to communicate with the third accommodating cavity 2054, the base station 2000 further includes a debris inlet channel. The third inlet of the second filtering box communicates with the debris inlet 2100 through the debris inlet channel, so that the debris in the first filtering box 1051 of the swimming pool robot enters the second filtering box through the debris inlet channel and then is filtered out by the second filtering box. Alternatively, in another embodiment, if the third accommodating cavity 2054 is located in front of the fifth accommodating cavity 200012, the base station 2000 may not be provided with the debris inlet channel, and the debris inlet 2100 of the base station body 20001 directly communicates with the third accommodating cavity 2054.

In one embodiment, as shown in FIG. 3, the fifth accommodating cavity 200012 includes a fourth cavity 20006 and a fifth cavity 20007. The water quality testing assembly is provided in the fourth cavity 20006, and the second reagent spreading assembly 2160 is provided in the fifth cavity 20007. The fourth cavity 20006 and the fifth cavity 20007 may be arranged side-by-side, for example, arranged in a left-right direction or a front-back direction. In this case, the user can remove or place the water quality testing assembly and the second reagent spreading assembly in a pull-out manner in a height direction of the base station 2000. For example, the base station 2000 further includes a second upper cover 20005 provided at a top opening of the base station body 20001. The second upper cover 20005 is detachably provided on the base station body 20001. When the second upper cover 20005 is opened, a top opening of the third accommodating cavity 2054, a top opening of the fourth cavity 20006, and a top opening of the fifth cavity 20007 all communicate with the outside, so that the second filtering box 21102, the water quality testing assembly, and the second reagent spreading assembly 2160 can be conveniently removed or placed through the top opening of the base station body 20001.

Because the second filtering box 21102 needs to be provided in the third accommodating cavity 2054, large space is occupied. To enable the base station body 20001 to be thin, the fourth cavity 20006 and the fifth cavity 20007 are arranged side-by-side in the left-right direction, or the fourth cavity 20006 and the fifth cavity 20007 are stacked in the height direction of the base station body 20001. In this case, the user can horizontally remove or place the water quality testing assembly and the second reagent spreading assembly in a pull-out manner.

The water quality testing assembly is configured to test water in the swimming pool, and the second reagent spreading assembly 2160 is configured to spread a reagent in the water of the swimming pool. In one embodiment, the base station body 20001 is at least partially located below the water surface of the swimming pool. Because only an inner cavity of the first sealed box 2290 of the base station 2000 is a sealed cavity, the liquid in the swimming pool cannot enter the first sealed box 2290 and can enter other regions in the base station body 20001. The fourth cavity 20006 and the fifth cavity 20007 are in communication with the liquid in the swimming pool. The water quality testing assembly directly tests liquid entering the fourth cavity 20006. The second reagent spreading assembly 2160 spreads a reagent to liquid in the fifth cavity 20007. Because the water in the fourth cavity 20006 and the fifth cavity 20007 and the liquid in the swimming pool are always in a flowing state, water quality information obtained by the water quality testing assembly is also accurate, and the reagent spread by the second reagent spreading assembly 2160 can quickly flow to the liquid at different positions in the swimming pool, to implement reagent spreading.

The second reagent spreading assembly 2160 may further spread a reagent in the liquid in the swimming pool in another manner. The second reagent spreading assembly 2160 includes a second reagent storage assembly 2161 and a second spreading drive assembly 2162. The second reagent storage assembly is provided with a second reagent opening 21611. The second spreading drive assembly 2162 is configured to allow a reagent in the second reagent storage assembly to be discharged through the second reagent opening 21611 and be spread in the liquid in the swimming pool.

In one embodiment, as shown in FIG. 4 and FIG. 5, the second spreading drive assembly 2162 is provided in the first sealed box 2290. A liquid inlet end of the second reagent spreading assembly communicates with the second reagent opening 21611 through a third duct, and a liquid outlet end of the second reagent spreading assembly transmits a reagent into the liquid discharge channel 2200 through a fourth duct, and finally, the reagent is discharged in the liquid in the swimming pool through the water discharge opening 2120. Under the base station water pump 20002, the liquid filtered by the second filtering box 21102 enters the liquid discharge channel 2200, the second reagent spreading assembly 2160 transmits the reagent into the liquid discharge channel 2200, and the reagent is discharged with liquid in the liquid discharge channel 2200 into the liquid in the swimming pool through the water discharge opening 2120, to implement reagent spreading.

In other words, in this embodiment, the water discharge opening 2120 is in communication with the liquid in the swimming pool, and the liquid discharged through the water discharge opening 2120 returns to the swimming pool, so that circulated water for cleaning the first filtering box is formed. Specifically, the fourth cavity 20006 and the fifth cavity 20007 are arranged side by side in the left-right direction and are located in front of the third accommodating cavity 2054, so that the second reagent opening 21611 of the second reagent storage assembly is conveniently connected to the second spreading drive assembly of the first sealed box 2290 without increasing a thickness of the base station 2000, leading to compact arrangement of the entire base station 2000.

In some embodiments, the liquid discharge channel 2200 of the base station 2000 is located below the water surface of the swimming pool, the liquid discharged through the liquid discharge channel 2200 directly enters the swimming pool, and the reagent spread by the second reagent spreading assembly 2160 directly enters the liquid in the swimming pool through the liquid discharge channel.

For example, the base station body 20001 is at least partially located underwater, so that the liquid discharge channel 2200 is located below the water surface, or the base station body 20001 is entirely located underwater or submerged below the water surface, so that the fourth cavity 20006 and the liquid discharge channel 2200 are both located below the water surface of the swimming pool, and the liquid in the fourth cavity 20006 always remains in communication with and circulates with the liquid in the swimming pool, to ensure testing accuracy of the water quality testing assembly in the fourth cavity 20006.

The cleaning water for cleaning the first filtering box 1051 may be the liquid in the swimming pool or water outside the swimming pool. The cleaning water may enter the first filtering box 1051 through the second water inlet, a top opening of the body, or the first water outlet. The top opening of the body is the putting-in and taking-out opening configured to allow the filtering box to be placed or removed. Alternatively, a self-cleaning water inlet may be independently provided on the swimming pool robot to serve as an inlet for the water to enter the first filtering box 1051 to clean the first filtering box 1051.

In one embodiment, as shown in FIG. 3 and FIG. 4, the base station 2000 includes a second filtering box cavity 2150. An inner cavity of the second filtering box cavity 2150 serves as the third accommodating cavity 2054. The second filtering box cavity 2150 is provided with a fourth opening. The fourth opening communicates with the self-cleaning debris inlet 2100 through the debris inlet channel. The base station 2000 further includes a sixth baffle plate. The sixth baffle plate is movably provided at the fourth opening, the debris inlet 2100, or any position in the debris inlet channel. When the base station water pump 20002 is turned off, the sixth baffle plate prevents the water or the debris-loaded water from entering the second filtering box 21102 through the debris discharge opening 1300 of the swimming pool robot. In other words, when the swimming pool robot returns to the base station 2000 for cleaning the first filtering box 1051, the sixth baffle plate is in an open state, so that the debris or the debris-loaded water in the first filtering box 1051 of the swimming pool robot can enter the second filtering box 21102, and after the base station 2000 finishes cleaning the first filtering box 1051 of the swimming pool robot, when the base station water pump 20002 is turned off, or the swimming pool robot leaves the base station 2000, the sixth baffle plate is in a closed state, so that the debris or the debris-loaded water in the first filtering box 1051 of the swimming pool robot cannot enter the second filtering box 21102.

For example, the sixth baffle plate is made of soft rubber. When the base station water pump 20002 is turned on, negative pressure is formed in the third accommodating cavity 2054 under the base station water pump 20002. Under the negative pressure, the sixth baffle plate moves to expose the fourth opening, so that the debris or the debris-loaded water in the first filtering box 1051 of the swimming pool robot enters the second filtering box 21102. When the base station water pump 20002 is turned off, the negative pressure in the third accommodating cavity 2054 is withdrawn, and the sixth baffle plate moves toward the fourth opening to cover the fourth opening.

In some embodiments, the second filtering box 21102 may be replaced with a debris bag or a filtering bag. When the swimming pool robot returns to the base station 2000, the debris in the first filtering box 1051 enters the filtering bag through the debris inlet 2100 and then is filtered out. The second upper cover 20005 is opened, so that the filtering bag in the second filtering box cavity 2150 can be conveniently placed, removed, and replaced. The filtering bag may be a disposable filtering bag or a filtering bag that may be cyclically used for a plurality of times.

In some embodiments, the swimming pool robot further includes a first reagent spreading assembly configured to spread a reagent into the swimming pool when the swimming pool robot moves in the swimming pool. The base station 2000 is provided with a reagent replenishment assembly. When the swimming pool robot returns to the base station, an outlet of the reagent replenishment assembly is docked with a reagent replenishment opening of the first reagent spreading assembly, and the reagent is replenished to the swimming pool robot 1000 under a drive mechanism.

When the swimming pool robot returns to the base station, the base station can perform at least one of the following operations on the swimming pool robot: charging the swimming pool robot; cleaning the first filtering box; communicating with the swimming pool robot; replacing the first reagent spreading assembly or the reagent; automatically replacing the water quality testing assembly, or allowing the swimming pool robot to dock.

In some embodiments, in a process in which the swimming pool robot returns to the base station, to ensure that the swimming pool robot can accurately return to the base station, a first docking assembly 1010 is provided on a side portion or the bottom of the swimming pool robot 1000, and a second docking assembly 2030 is provided on the base station. The first docking assembly 1010 is releasably connected to the second docking assembly 2030. When the first docking assembly 1010 is connected to the second docking assembly 2030, the swimming pool robot is connected to or locked to the base station. When the first docking assembly 1010 is separated from the second docking assembly 2030, the swimming pool robot is disconnected from the base station and can leave the base station.

For example, a releasable connection between the first docking assembly and the second docking assembly includes at least one of the following: a magnetic connection; a mechanical locking connection; a snap-fit connection, or a threaded connection.

For example, as shown in FIG. 18, one of the first docking assembly and the second docking assembly is an insertion groove, and the other is an insertion member. For example, the swimming pool robot is provided with an insertion groove, and an insertion member is provided at the first end of the carrying member or on the base station body. When the insertion member is inserted into the insertion groove, the swimming pool robot is docked with the base station. For another example, a magnet is disposed on one of the swimming pool robot and the base station, and an iron block is disposed on the other of the swimming pool robot and the base station, so that the swimming pool robot is locked to the base station through magnetic attraction between the magnet and the iron block, or a first magnet is disposed on one of the swimming pool robot and the base station, a second magnet is disposed on the other of the swimming pool robot and the base station, and a magnetic pole of one end of the first magnet is opposite to a magnetic pole of one end of the second magnet, where the end of the first magnet faces the end of the second magnet.

In some embodiments, as shown in FIG. 12, a first end of the swimming pool robot is the rear portion, and a second end is the front portion of the swimming pool robot. The second water inlet and the first docking assembly are provided on the first end. Alternatively, as shown in FIG. 1, the first end of the swimming pool robot is the front portion, and both the second water inlet and the first docking assembly are provided on the front portion of the swimming pool robot.

Whether the swimming pool robot returns to the base station may be determined based on whether the first docking assembly is docked with the second docking assembly, or the debris inlet is docked with the debris discharge opening. Generally, when the first docking assembly is docked with the second docking assembly, the debris inlet is also docked with the debris discharge opening. In some embodiments, the first docking assembly and the debris discharge opening are provided on a same wall of the swimming pool robot, for example, on the bottom or a bottom wall, a side wall, or a top wall or the top of the swimming pool robot. The second docking assembly and the debris inlet are provided on a same wall of the base station body or the carrying member, for example, a front side wall, a left side wall, a right side wall, the top or a top wall, or the bottom or a bottom wall of the base station body. In this way, when the first docking assembly is docked with the second docking assembly, the debris inlet is also docked with the debris discharge opening.

Further, the cleaning system includes an in-position detection mechanism configured to detect that the swimming pool robot returns to the base station, and the first docking assembly and the second docking assembly are docked in position. For example, the in-position detection mechanism includes a Hall sensor and a magnet. One of the magnet and the Hall sensor is provided on the swimming pool robot, and the other is provided on the base station. When detecting the magnet, the Hall sensor generates a docking signal, indicating that the swimming pool robot and the base station are docked in position. Alternatively, the in-position detection mechanism is a microswitch. For example, the microswitch includes a trigger member and a stopper. One of the trigger member and the stopper is provided on the swimming pool robot, and the other is provided on the base station. When the trigger member is in contact with the stopper and then generates a docking signal, it indicates that the swimming pool robot 1000 and the base station are docked in position.

In some embodiments, the base station 2000 is provided with a charging assembly 2090. The swimming pool robot 1000 is provided with a charging receiving member 1020. When the swimming pool robot returns to the base station, the charging assembly charges the charging receiving member 1020, so that the swimming pool robot is charged.

In some embodiments, when the swimming pool robot returns to the base station, the swimming pool robot may climb on the pool wall, be located below the water surface, stop at the waterline, or stop on the water surface. Therefore, the charging assembly charges the swimming pool robot under the water surface or at the waterline. For example, when the charging assembly is disposed at the waterline, the charging assembly charges the swimming pool robot at the waterline, or when the charging assembly is located below the water surface, the charging assembly charges the swimming pool robot below the water surface. Alternatively, there are a plurality of charging assemblies. The plurality of charging assemblies are sequentially arranged on the base station body in the height direction of the base station body, so that the charging assemblies 2090 can charge the charging receiving member at different positions in the height direction of the base station body.

In some embodiments, as shown in FIG. 3, the base station 2000 charges the swimming pool robot through a wireless charging module. For example, the wireless charging module includes a first coil and a second coil. The second coil 20911 is provided on the base station body 20001 (that is, the charging assembly includes the second coil), and the first coil is provided on the swimming pool robot (that is, the charging receiving member includes the first coil). The second coil on the base station 2000 charges the first coil on the swimming pool robot through wireless contact. According to a wireless charging manner, the charging assembly and the charging receiving member are prevented from being directly exposed to the liquid, so that a service life of each of the charging assembly and the charging receiving member cannot be affected.

In some embodiments, the first coil, the first docking assembly, and the debris discharge opening are all located on a same wall of the swimming pool robot. Similarly, the second coil, the second docking assembly, and the debris inlet 2100 are all located on a same wall of the base station body 20001.

When the swimming pool robot returns to the base station, the swimming pool robot may return to the base station on the pool wall, the bottom wall of the swimming pool, or the water surface.

The swimming pool robot includes the floating-submerging mechanism, so that the swimming pool robot can float on the water surface and be switched from a position on the pool wall to a position on the water surface or from a position on the water surface to a position on the pool wall or a position on the pool bottom. The swimming pool robot includes the moving mechanism, so that the swimming pool robot can move on the pool wall or the pool bottom Therefore, the swimming pool robot has a first state in which the swimming pool robot moves on the pool bottom, a second state in which the swimming pool robot moves on or stops on the pool wall, and a third state in which the swimming pool robot floats on the water surface.

In one embodiment, the first docking surface 20004 is a front side wall, a rear side wall, a left side wall, or a right-side wall of the base station body or the carrying member, and the swimming pool robot returns to the base station in a same action.

An example in which the front side wall of the base station body is the first docking surface 20004 is used to describe a process in which the swimming pool robot moves upward on a pool wall (for example, a front side wall) on which the base station body is located, to return to the base station from a position below the base station body.

When the swimming pool robot receives a return signal instructing the swimming pool robot to return to the base station, the swimming pool robot returns from a current position of the swimming pool robot to the front side wall on which the base station is located, and then the swimming pool robot moves on the front side wall, so that the swimming pool robot can move upward from the position below the base station body to the base station.

In some embodiments, as shown in FIG. 25, if the swimming pool robot 1000 is currently located at the bottom wall 310 of the swimming pool, the swimming pool robot may first move from the bottom wall 310 of the swimming pool to the front side wall 320 of the swimming pool, and the swimming pool robot continues to move upward on the front side wall 320 and then moves upward from the position below the base station body to the front side wall of the base station body. During this process, the swimming pool robot adjusts a posture of the swimming pool robot, so that the debris discharge opening 1300 on the bottom of the swimming pool robot can be docked with the debris inlet 2100 on the front side wall of the base station body, enabling the swimming pool robot to return to the base station.

An action of adjusting the posture of the swimming pool robot includes at least one of.

The swimming pool robot moves upward or downward, moves rightward or leftward, twists leftward or rightward, rotates, or laterally moves on the front side wall or the first docking surface. The swimming pool robot adjusts the posture until the debris discharge opening is docked with the debris inlet.

In some embodiments, the swimming pool robot first adjusts the posture below the base station body, enabling the swimming pool robot to be located right below the base station body, so that the swimming pool robot directly moves upward from the position below the base station body to the front side wall of the base station body and then is docked with the base station. Alternatively, the swimming pool robot adjusts the posture of the swimming pool robot while the swimming pool robot moves upward from the position below the base station body toward the base station body, or the swimming pool robot may first move upward from the position below the base station body to the front side wall of the base station body without adjusting the posture of the swimming pool robot, and then the swimming pool robot adjusts the posture of the swimming pool robot on the front side wall of the base station body.

Alternatively, when the swimming pool robot is located below the base station, before moving upward to the front side wall of the base station body, the swimming pool robot adjusts the posture for the first time, enabling the swimming pool robot to be located right below the base station body; in a process in which the swimming pool robot moves toward the front side wall of the base station body, the swimming pool robot may or may not adjust the posture for the second time; and when the swimming pool robot is located on the front side wall, the swimming pool robot adjusts the posture for the third time until the debris inlet is docked with the debris discharge opening.

Alternatively, in a process in which the swimming pool robot moves upward from the position below the base station body to the front side wall of the base station body, the swimming pool robot adjusts the posture of the swimming pool robot at any time until the debris inlet is docked with the debris discharge opening.

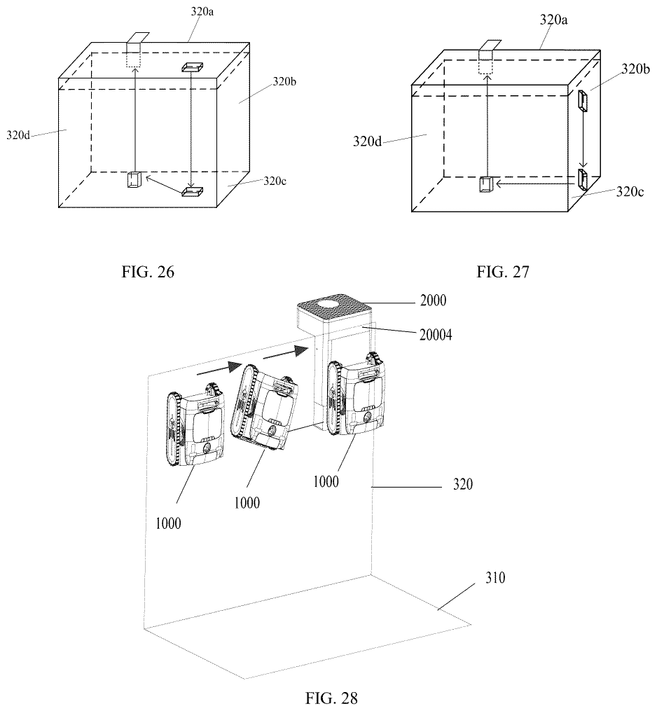

In some embodiments, when the swimming pool robot receives the return signal instructing the swimming pool robot to return to the base station, if the swimming pool robot is currently located on the water surface, as shown in FIG. 26, the swimming pool robot is first directly switched from a position on the water surface (namely, the third state) to a position on the pool bottom (namely, the first state), and then moves from the pool bottom to a pool wall (namely, the second state) on which the base station is located. When the swimming pool robot moves to the pool wall on which the base station is located, the swimming pool robot moves upward on the pool wall from a position below the base station body to return to the base station body.

Alternatively, when the swimming pool robot receives the return signal instructing the swimming pool robot to return to the base station, if the swimming pool robot is currently located on a pool wall on which the base station is located, the swimming pool robot moves upward on the pool wall from a position below the base station body to return to the base station.

Alternatively, as shown in FIG. 27, if the swimming pool robot and the base station body are located on different pool walls, the swimming pool robot needs to first move from a pool wall on which the swimming pool robot is currently located to the pool bottom, then move from the pool bottom to a pool wall on which the base station is located, and then move upward from a position below the base station body to return to the base station. Alternatively, the swimming pool robot is first switched from a position on the pool wall on which the swimming pool robot is currently located to a position on the water surface and then switched from the position on the water surface to a position on the pool wall on which the base station is located, and then the swimming pool robot moves upward on the pool wall from a position below the base station body to return to the base station. In other words, if the pool wall on which the swimming pool robot is currently located is not the pool wall on which the base station body is located, the swimming pool robot needs to first move to the pool bottom and then move to the pool wall or first move to the water surface and then move to the pool wall, and then the swimming pool robot moves upward on the pool wall on which the base station is located from a position below the base station body to return to the base station.

For example, as shown in FIG. 27, side walls of the swimming pool include at least a first side wall 320a, a second side wall 320b, a third side wall 320c, and a fourth side wall 320d sequentially connected end to end, and each side wall may be an arc surface, a curved surface, or a vertical surface. In one embodiment, if the base station body is disposed on the first side wall 320a, and the swimming pool robot is located on the second side wall 320b, the third side wall, or the fourth side wall when the swimming pool robot receives the signal instructing the swimming pool robot to return to the base station, the swimming pool robot may first move from the second side wall 320b, the third side wall, or the fourth side wall to the bottom wall of the swimming pool, that is, the swimming pool robot is first switched from the second state to the first state, and then the swimming pool robot moves on the bottom wall of the swimming pool robot to approach the first side wall 320a. When the swimming pool robot moves from the bottom wall of the swimming pool to the first side wall, the swimming pool robot moves upward on the first side wall from a position below the base station body to return to the first docking surface of the base station body.

In other embodiments, when the swimming pool robot receives the return signal instructing the swimming pool robot to return to the base station, the swimming pool robot returns to a pool wall on which the base station is located from a current position of the swimming pool robot, and then the swimming pool robot laterally moves on the pool wall on which the base station is located to return to the base station. An example in which the base station is located on the first side wall is used for description.

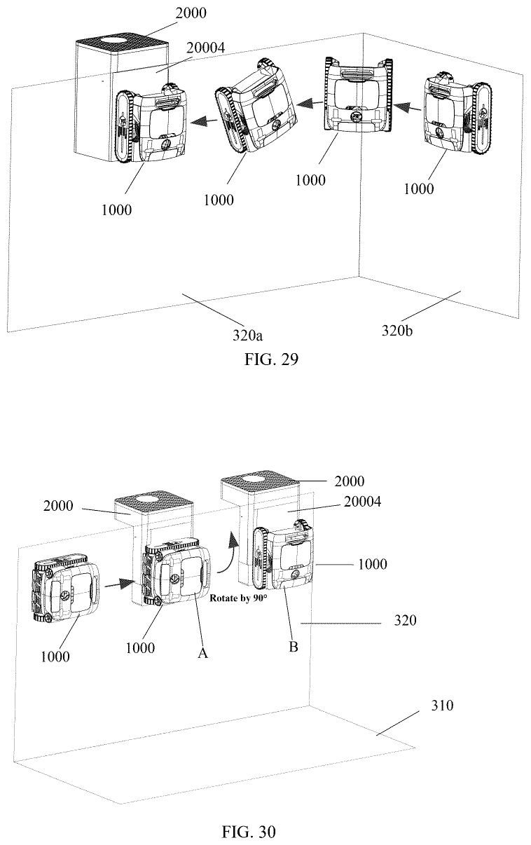

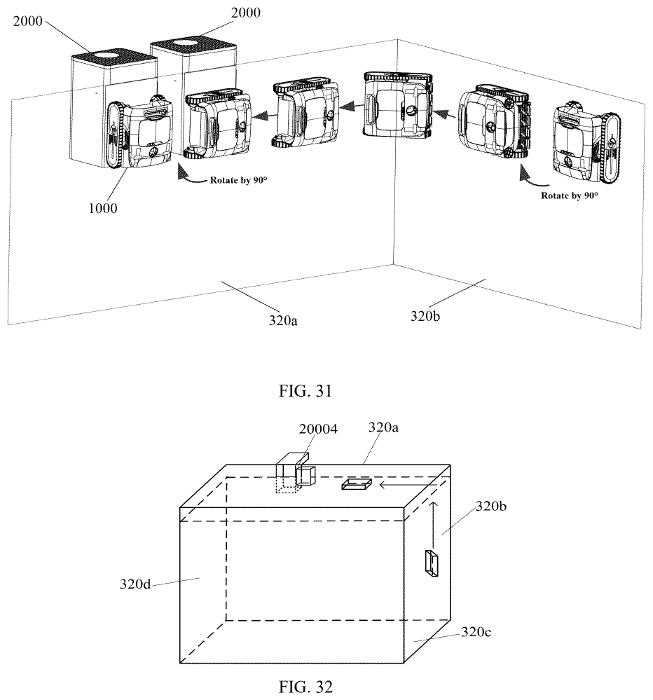

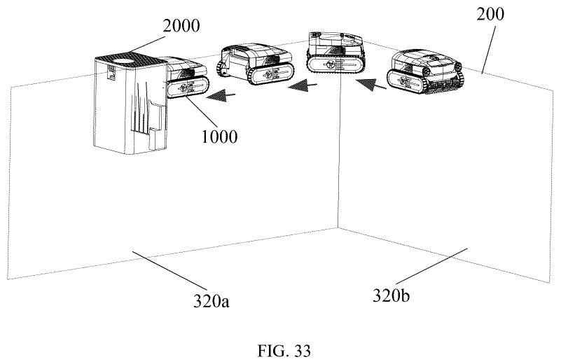

For example, when the swimming pool robot is currently located on the pool bottom, the swimming pool robot moves from the pool bottom to the first side wall. Alternatively, when the swimming pool robot is currently located on the water surface, the swimming pool robot is first switched from a position on the water surface to a position on the pool bottom, and then moves from the pool bottom to the first side wall, or the swimming pool robot is switched from a position on the water surface to a position the first side wall. Alternatively, the swimming pool robot is located on a pool wall different from the first side wall. For example, the base station body is located on the first side wall, and the swimming pool robot is currently located on the second side wall. In this case, the swimming pool robot is first switched from a position on the second side wall to a position on the pool bottom and then switched from a position on the pool bottom to a position on the first side wall, or the swimming pool robot is first switched from a position on the second side wall to a position on the water surface and then switched from a position on the water surface to a position on the first side wall. Alternatively, as shown in FIG. 29, the swimming pool robot directly moves from the second side wall to the first side wall, and the swimming pool robot may laterally move, or as shown in FIG. 31, if a moving direction of the swimming pool robot is a vertical direction, the swimming pool robot first rotates by 90°, enabling the front portion of the swimming pool robot to face the first side wall, and then the swimming pool robot moves forward from the second side wall to the first side wall.

Alternatively, when the swimming pool robot is currently located on the first side wall, the swimming pool robot moves laterally on the first side wall to return to the base station.

Specifically, as shown in FIG. 28, the swimming pool robot moves on the side wall 320 of the swimming pool. When the swimming pool robot is at a height substantially the same as that of the base station body, the swimming pool robot moves laterally from the outside of the side wall of the base station body to the front side wall of the base station body. During this process, the swimming pool robot adjusts the posture, enabling the debris discharge opening on the bottom of the swimming pool robot to be docked with the debris inlet. An action of adjusting the posture of the swimming pool robot includes at least one of. The swimming pool robot moves upward or downward, moves rightward or leftward, twists, rotates, or laterally moves on the pool wall on which the base station is located. The swimming pool robot adjusts the posture until the debris discharge opening is docked with the debris inlet. Alternatively, the swimming pool robot rotates, twists, or moves on the base station body to adjust the posture of the swimming pool robot until the debris discharge opening is docked with the debris inlet.

Alternatively, as shown in FIG. 30, when the swimming pool robot is located on the first side wall on which the base station is located, the swimming pool robot first adjusts the posture on the first side wall, enabling the moving direction of the swimming pool robot to be perpendicular to or intersect the height direction of the base station body, and then the swimming pool robot moves forward or backward to the base station body. Then, the swimming pool robot rotates by 90° or another angle on the base station body to adjust the moving direction of the swimming pool robot, enabling the moving direction of the swimming pool robot to be parallel to the height direction of the base station body. During this process, the swimming pool robot rotates and/or moves to adjust the posture of the swimming pool robot, so that the debris discharge opening is docked with the debris inlet.

In other embodiments, the swimming pool robot moves from the water surface back to the base station. If the swimming pool robot is not currently located on the water surface, the swimming pool robot needs to be first switched from a current position to a position on the water surface and then return to the base station from the water surface.

For example, when the swimming pool robot is currently located on the pool bottom, the swimming pool robot is first switched from a position on the pool bottom to a position on the pool wall and then switched from a position on the pool wall to a position on the water surface, or as shown in FIG. 32, when the swimming pool robot is currently located on the pool wall, the swimming pool robot is switched from a position on the pool wall to a position on the water surface.

In some embodiments, the debris discharge opening 1300 is provided on the bottom of the swimming pool robot. If the debris inlet is provided on a right-side wall of the base station body, the right-side wall of the base station body serves as the first docking surface 20004, or if the debris inlet is provided on a front side wall of the base station body, the front side wall serves as the first docking surface.

In some embodiments, when the swimming pool robot is located on the water surface, the swimming pool robot moves back to the base station along an edge of the water surface. For example, the swimming pool robot moves toward the first docking surface of the base station along an edge (or a waterline) of the water surface. As shown in FIG. 32, the swimming pool robot moves forward along the edge of the water surface until the front portion of the swimming pool robot abuts against the first docking surface, or the swimming pool robot moves backward along the edge of the water surface until the rear portion of the swimming pool robot abuts against the first docking surface, and then the swimming pool robot is switched from the third state to the second state. In this case, the swimming pool robot does not climb on the pool wall, but climbs on the first docking surface of the base station body, that is, the bottom of the swimming pool robot abuts against the first docking surface. The swimming pool robot adjusts the posture on the first docking surface, enabling the debris inlet to be docked with the debris discharge opening. Correspondingly, the first docking assembly is docked with the second docking assembly. In this way, the swimming pool robot returns to the base station from the water surface.

An action of adjusting the posture of the swimming pool robot includes at least one of.

The swimming pool robot moves upward or downward, moves rightward or leftward, twists, rotates, or laterally moves on the first docking surface.

In other embodiments, the debris discharge opening is provided on the front portion of the swimming pool robot. For example, the debris discharge opening may be the second water inlet or an opening provided on the front portion of the swimming pool robot independently of the second water inlet. When the swimming pool robot returns to the base station along the edge of the water surface, the swimming pool robot moves forward until the front portion of the swimming pool robot abuts against or collides with the first docking surface, and then the swimming pool robot adjusts the posture, enabling the debris discharge opening to be docked with the debris inlet. In this way, the swimming pool robot returns to the base station along the edge of the water surface.

Alternatively, the swimming pool robot may move backward to the base station along the edge until the rear portion of the swimming pool robot abuts against the first docking surface, and then the swimming pool robot rotates in situ to adjust the posture of the swimming pool robot, so that the front portion of the swimming pool robot abuts against the first docking surface, enabling the self-cleaning debris discharge opening to be docked with the self-cleaning debris inlet.

In some embodiments, the first docking assembly and the debris discharge opening are provided on a same wall of the swimming pool robot, and the second docking assembly and the debris inlet are provided on a same wall of the base station. When the first docking assembly is docked with the second docking assembly, correspondingly, the debris discharge opening is docked with the debris inlet.

In some embodiments, as shown in FIG. 15 and FIG. 22, the carrying member 2040 is disposed along a direction substantially parallel to the pool bottom wall or substantially perpendicular to the first side surface 2025a of the support member. As shown in FIG. 14, when the first docking assembly is provided on the rear side surface of the rear portion of the swimming pool robot, the swimming pool robot moves on the water surface or moves along the edge of the water surface until the front portion of the swimming pool robot abuts against the first side surface 2050a. Then, the swimming pool robot is switched from operating on the water surface to climbing on the first side surface, and the swimming pool robot moves downward and backward on the first side surface until the first docking assembly is docked with the second docking assembly. In this way, the swimming pool robot returns to the base station.

In some embodiments, the swimming pool robot shown in FIG. 12 is used as an example for describing how the swimming pool robot returns to the base station.

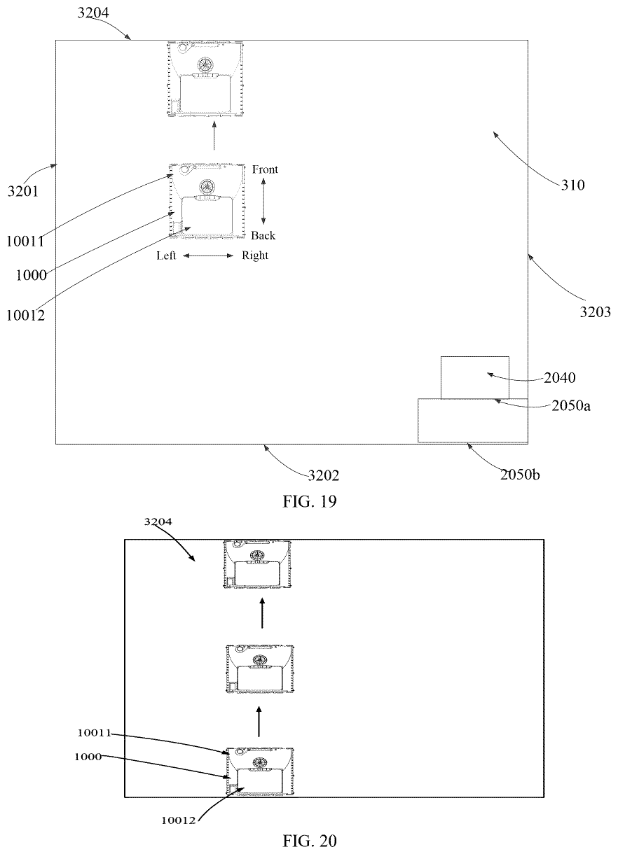

Specifically, as shown in FIG. 19, an example in which the swimming pool is rectangular is used. Walls or side walls of the swimming pool include a first wall 3201, a second wall 3202, a third wall 3203, and a fourth wall 3204 sequentially connected end to end. The base station 2000 is disposed at a joint between the second wall 3202 and the third wall 3203. For example, the support member 2050 includes a first side surface 2050a and a second side surface 2050b opposite to each other. The second side surface 2050b faces or abuts against the second wall. The second side surface 2050b faces the fourth wall 3204, and the carrying member 2040 is fixed on the first side surface 2050a and located underwater.

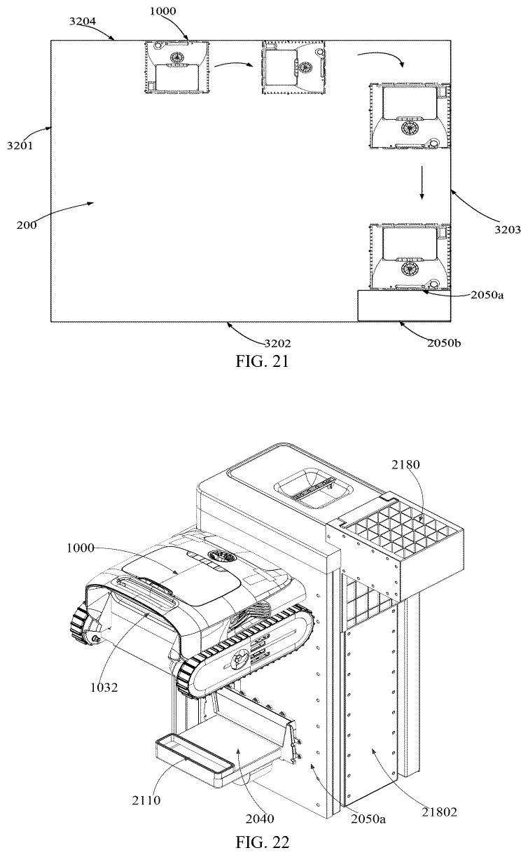

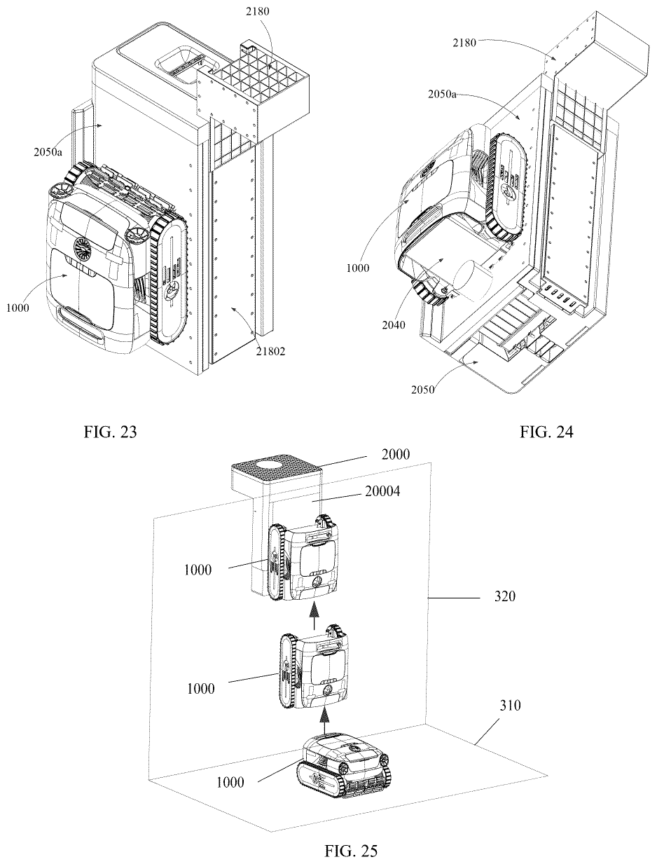

As shown in FIG. 19, if the swimming pool robot initially performs cleaning on the pool bottom, when receiving the signal instructing the swimming pool robot to return to the base station, the swimming pool robot first searches for a wall closest to the swimming pool robot, for example, a wall closest to the swimming pool robot in the forward direction of the swimming pool robot. Assuming that the swimming pool robot is closest to the fourth wall, the swimming pool robot first moves forward toward the fourth wall on the pool bottom and then climbs the fourth wall, that is, the swimming pool robot is switched from the first state to the second state. Then, as shown in FIG. 20, the swimming pool robot moves on the fourth wall toward the waterline, and the swimming pool robot is switched from a position on the fourth wall to a position on the water surface when the swimming pool robot is close to the waterline on the fourth wall, that is, the swimming pool robot is switched from the second state to the third state. As shown in FIG. 21, the swimming pool robot performs steering, enabling one side portion (for example, a right side portion or a left side portion) used when the swimming pool robot moves along an edge to be attached to or close to the waterline on the fourth wall. Assuming that the swimming pool robot is in a left edge-moving mode, the left side portion of the swimming pool robot is attached to or close to the fourth wall, and the swimming pool robot moves forward toward the base station along edges of the fourth wall 3204 and the third wall 3203, that is, the swimming pool robot moves toward the base station along the edge of the water surface, until the front portion of the swimming pool robot collides with the first side surface 2050a. In other words, as shown in FIG. 21 and FIG. 22, the front portion of the swimming pool robot abuts against the first side surface 2050a, and the left side portion of the swimming pool robot is close to or attached to the third wall 3203. Then, the swimming pool robot is switched from the third state to the second state, enabling the swimming pool robot to climb on the first side surface and the bottom of the swimming pool robot to abut against the first side surface 2050a of the support member 2050. Then, the swimming pool robot moves downward and backward on the first side surface 2050a until the first docking assembly (for example, the insertion groove) of the swimming pool robot mates with the second docking assembly (for example, the insertion member), that is, the swimming pool robot is docked with the base station. As shown in FIG. 23 and FIG. 24, the swimming pool robot returns to the base station. In contrast, if the swimming pool robot needs to leave the base station after implementing a corresponding task on the base station, the swimming pool robot moves upward on the first side surface 2050a of the support member, so that the first docking assembly is separated from the second docking assembly.

An action that the swimming pool robot shown in FIG. 12 returns to the base station is the same as an action that the swimming pool robot shown in FIG. 7 returns to the base station. The difference is that the debris discharge opening of the swimming pool robot in FIG. 7 is provided on the bottom of the swimming pool robot, and the debris discharge opening of the swimming pool robot in FIG. 12 is the second water inlet provided on the rear portion of the swimming pool robot.

In some embodiments, to prevent the carrying member from affecting movement or a cleaning operation of the swimming pool robot, when the swimming pool robot does not need to return to the base station, or after the swimming pool robot leaves the base station, the carrying member may be switched from a substantially horizontal state to a state of being substantially parallel to the first side surface. For example, the carrying member is rotatably provided on the base station body. When the swimming pool robot leaves the base station, the carrying member rotates, so that the carrying member is switched from substantially perpendicular to the first side surface to substantially parallel to the first side surface and then is retracted to the base station body.

In other embodiments, when the swimming pool robot is located on the water surface, the swimming pool robot does not return to the base station along the edge of the water surface, and the swimming pool robot may move to the first docking surface of the base station from any position on the water surface, enabling the debris discharge opening of the swimming pool robot to face the first docking surface, and then the posture and the position of the swimming pool robot are adjusted, enabling the debris discharge opening to be docked with the debris inlet. In this way, the swimming pool robot returns to the base station from the water surface.

In a process of cleaning the first filtering box, the power assembly of the base station may be used, and the main water pump 1061 of the swimming pool robot is turned off; the main water pump of the swimming pool robot may be used to implement self-cleaning, and the power assembly of the base station is turned off; or both the main water pump of the swimming pool robot and the power assembly of the base station may be turned on. For example, when the main water pump rotates forward, the swimming pool robot performs a cleaning task, and when the main water pump rotates reversely, the liquid in the swimming pool is sucked into the first filtering box through the first water outlet to clean the first filtering box.

Some embodiments of the present disclosure provide a swimming pool robot control method. The method specifically includes the following steps.

Step S110: A swimming pool robot receives a return signal.

In some embodiments, the return signal is at least one of the following: A cleaning task is completed, a battery level of the swimming pool robot is lower than a battery level threshold, a debris collection amount of a filtering box of the swimming pool robot is greater than a preset value, the filtering box of the swimming pool robot needs to be cleaned, a reagent amount of a first reagent spreading assembly is less than a reagent amount threshold, or the swimming pool robot receives a return instruction sent by a user. The return signal is used to instruct the swimming pool robot to return to a base station. For example, the return signal is generated by a terminal device (for example, a mobile phone, or a remote control). The swimming pool robot moves to the base station after receiving the return signal generated by the terminal device and then can berth at the base station, and the swimming pool robot is charged or debris in a first filtering box is cleaned on the base station.

S130: The swimming pool robot moves toward the base station.

When the swimming pool robot receives the return signal, the swimming pool robot may move toward the base station along a return path until the swimming pool robot berths at the base station.

The return path includes at least one of the following: a fixed path, a first random path, or a second random path. The first random path is a path on which the swimming pool robot randomly moves to the base station from a current position of the swimming pool robot when the base station is unknown. The second random path is a path on which the swimming pool robot moves to the base station when the base station is known.

The first random path may be a path on which swimming pool robot randomly moves along a bottom, a wall, or a water surface of a swimming pool until the swimming pool robot finds the base station. The second random path may be a straight path, a curved path, or the like from the swimming pool robot to the base station.

For example, the fixed path includes a path for moving along an edge, and the path for moving along an edge includes at least one of the following: a path for moving along an edge of the bottom of the swimming pool, a path for moving along a waterline of the swimming pool, or a path for moving along an edge of the water surface.

In some embodiments, to improve returning accuracy of the swimming pool robot, before the swimming pool robot moves toward the base station, the method further includes the following step.

S120: Determine a relative position relationship between the swimming pool robot and the base station.

For example, the determining a relative position relationship includes at least one of: The swimming pool robot identifies the base station, the base station identifies the swimming pool robot, or the swimming pool robot identifies a position identifier associated with the base station. The return path is generated based on the relative position relationship between the swimming pool robot and the base station.

A scheme that the swimming pool robot identifies the base station is the same as a scheme that the base station identifies the swimming pool robot. For ease of description, an example in which the swimming pool robot identifies the base station is used in the following embodiments. For example, when the swimming pool robot collides with the base station in a process of moving on an inner wall (for example, the pool bottom or the pool wall) or the water surface of the swimming pool, it indicates that the swimming pool robot identifies the base station.

For another example, the swimming pool robot is provided with a first sensing member, the base station is provided with a second sensed member, and when the first sensing member senses the second sensed member, it indicates that the swimming pool robot identifies the base station.

In some embodiments, the first sensing member is a vision sensing assembly. The vision sensing assembly collects image data in real time, and target detection is performed on the image data, so that a position of the base station is determined based on a detection result. For example, the vision sensing assembly may be one of a monocular camera, a binocular camera, a trinocular camera, and a surround-view camera. In other words, the vision sensing assembly is a camera. Specifically, the vision sensing assembly may be provided on a top or a front portion of the swimming pool robot.

For another example, the swimming pool robot is provided with an identification assembly, a position identifier is provided on or near the base station, and the identification assembly is configured to identify the position identifier. There is a preset relationship between the position identifier and the position of the base station, and when the position identifier is identified, the position of the base station may be determined.

Alternatively, the base station may transmit a guidance signal to guide the swimming pool robot to identify the position of the base station. For example, the guidance signal is at least one of an infrared signal or an ultrasonic signal. The return path is generated based on the position of the base station.

Alternatively, the base station may transmit a near-field signal. The swimming pool robot is provided with a near-field signal detection unit. Alternatively, the base station may transmit a limiting signal, and the swimming pool robot is provided with a limiting signal detection unit.

In some embodiments, a signal transmitting apparatus for a signal such as the limiting signal, the guidance signal, and the near-field signal may be a floating apparatus, so that when the swimming pool robot moves on the water surface, the swimming pool robot can detect the signal more easily. This improves accuracy of the swimming pool robot in returning to the base station.

In some embodiments, the base station may directly communicate with the swimming pool robot, that is, the swimming pool robot may communicate with the base station to directly determine the position of the base station. For example, the position may be determined through communication such as Wi-Fi, Bluetooth, infrared, and radio.

In some embodiments, a return direction is determined based on distance information between the swimming pool robot and the base station, and the distance information between the swimming pool robot and the base station may be determined based on strength of a reflected signal or by using a distance measurement sensor. Higher strength of the reflected signal indicates a smaller distance between the swimming pool robot and the base station. When the strength of the reflected signal received by the base station gradually increases, a current moving direction of the swimming pool robot is the return direction. When the strength of the reflected signal received by the base station gradually decreases, a direction opposite to the current moving direction of the swimming pool robot is the return direction.

In one embodiment, the return direction is determined based on a preset relationship between the second sensed member and the base station. When the second sensed member having the preset relationship with the position of the base station is disposed in the swimming pool, the swimming pool robot detects the second sensed member in the swimming pool by using a first sensed member to determine a target position. The position of the base station is determined based on the target position and the preset relationship, and then the return direction may be determined based on the current position of the swimming pool robot and the position of the base station. The preset relationship may include a preset orientation of the target position relative to the base station.

S140: The swimming pool robot berths.

When the swimming pool robot moves close to the base station, the swimming pool robot may berth. In one embodiment, that the swimming pool robot berths specifically includes the following step.

S141: Control the swimming pool robot to move to the base station along the return path to perform a target event.

In some embodiments, the base station may always be in a state of being capable of performing carrying. That the base station is in the state of being capable of performing carrying indicates that the swimming pool robot can reach the base station via a side edge or a bottom edge of the base station, that is, the side edge or the bottom edge of the base station serves as an entrance for the swimming pool robot to move to the base station.

After the swimming pool robot moves to the base station, the swimming pool robot may perform the target event on the base station, and the target event includes at least one of cleaning the first filtering box, charging the swimming pool robot, or the like.

In some embodiments, the controlling the swimming pool robot to move to the base station along the return path may include: controlling the swimming pool robot to move to the base station in a first moving direction and/or a second moving direction. The first moving direction is a direction in which the swimming pool robot faces a side edge of the base station. The second moving direction is a direction in which a bottom edge of the swimming pool robot faces a top of the base station, that is, the second moving direction is also a direction in which the bottom of the swimming pool faces the top of the swimming pool. In other words, the swimming pool robot may move from the bottom edge or the side edge of the base station to the base station.

In some embodiments, the controlling the swimming pool robot to move to the base station along the return path may include any of the following manners.

Manner 1: If the side edge of the base station is low, and the swimming pool robot can directly climb on and pass the side edge of the base station, the swimming pool robot may be controlled to move from the side edge of the base station to the base station in the first moving direction, or the swimming pool robot may move from the bottom edge of the base station to the base station in the second moving direction.

Manner 2: If the side edge of the base station is high, the swimming pool robot cannot pass the side edge when the swimming pool robot moves to the base station via the side edge in the first moving direction. In a case where the swimming pool robot cannot move to the base station in the first moving direction, the swimming pool robot may be controlled to first bypass the side edge of the base station, enabling the swimming pool robot to be located below the base station, and then adjust a moving direction of the swimming pool robot to the second moving direction and move to the base station in the second moving direction. Controlling the swimming pool robot to adjust the moving direction to the second moving direction may be implemented by a drive apparatus of the swimming pool robot. The drive apparatus includes, but is not limited to, a moving wheel, a propeller, and the like.

Manner 3: The swimming pool robot may first return to the pool bottom, adjust the moving direction to the second moving direction on the pool bottom, move from the pool bottom to the pool wall in the second moving direction, and then move from the bottom edge of the base station to the base station. The bottom edge of the base station is an edge, of the base station, closest to the pool bottom.

In some embodiments, after the swimming pool robot returns to the base station along the return path, the swimming pool robot may move along a preset trajectory to find a stop position on the base station and then perform the target event at the stop position. The stop position is a position at which the first docking assembly of the swimming pool robot and the second docking assembly of the base station are docked in position.

After the swimming pool robot is controlled to move to the base station, the swimming pool robot is first controlled to move to the stop position on the base station, and then the second docking assembly at the stop position is connected to the first docking assembly of the swimming pool robot, so that the swimming pool robot is stably connected to the base station.

In some embodiments, the in-position detection mechanism may be used to detect whether the swimming pool robot moves to the stop position on the base station, and when it is detected that the swimming pool robot moves to the stop position, the swimming pool robot is controlled to stop moving, to remain located at the stop position.

In some embodiments, when the swimming pool robot moves to the base station, the base station may further send a trajectory change signal, and in response to the trajectory change signal sent by the base station, the swimming pool robot is controlled to change a current motion trajectory and then move to the base station.

For example, the swimming pool robot currently laterally moves along the pool wall, and after the trajectory change signal is sent, the swimming pool robot vertically moves along the pool wall to move to the base station located above the current position of the swimming pool robot.

In some embodiments, the controlling the swimming pool robot to move to the base station includes adjusting a pose of the swimming pool robot, enabling the swimming pool robot to stop at or be fixed on the base station.

When the swimming pool robot moves close to the base station, the swimming pool robot is not convenient to return to the base station in a current posture, so the pose of the swimming pool robot can be adjusted first, so that the swimming pool robot can conveniently return to the base station and be fixed to the base station body, or the swimming pool robot first moves to the base station, and then the swimming pool robot is controlled to adjust the pose or the posture on the base station, enabling the swimming pool robot to return to the stop position on the base station.

The swimming pool robot 1000 includes a memory 51 and a processor 52 coupled to each other. The processor 52 is configured to execute program instructions stored in the memory 51 to implement the steps of the swimming pool robot control method in any of the above embodiments. In one specific implementation scenario, the swimming pool robot 1000 may include, but is not limited to, a microcomputer and a server. In addition, the swimming pool robot 1000 may further include a mobile device, for example, a notebook computer or a tablet computer. This is not limited herein.

Specifically, the processor 52 is configured to control the processor and the memory 51 to implement the steps of the swimming pool robot control method in any of the above embodiments. The processor 52 may also be referred to as a central processing unit (Central Processing Unit, CPU). The processor 52 may be an integrated circuit chip having a signal processing capability. The processor 52 may alternatively be a general-purpose processor, a digital signal processor (Digital Signal Processor, DSP), an application-specific integrated circuit (Application-Specific Integrated Circuit, ASIC), a field-programmable gate array (Field-Programmable Gate Array, FPGA) or another programmable logic device, a discrete gate, a transistor logic device, or a discrete hardware component. The general-purpose processor may be a microprocessor, or the processor may be any conventional processor or the like. In addition, the processor 52 may be implemented by an integrated circuit chip.

In one embodiment, the swimming pool robot 1000 further includes a communication circuit. The communication circuit is configured to establish a connection with the base station and receive and send a related processing instruction, so that the swimming pool robot 1000 interacts with the base station.

The computer-readable storage medium 60 in this embodiment of the present disclosure stores program instructions 61. When the program instructions 61 are executed, the swimming pool robot control method in any embodiment of the present disclosure and any combination of embodiments with no conflict with each other is implemented.

The program instructions 61 may form a program file stored in the computer-readable storage medium 60 in a form of a software product, so that a computer device (which may be a personal computer, a server, a network device, or the like) performs all or some of the steps of the methods in embodiments of the present disclosure. The computer-readable storage medium 60 includes any medium that can store program code, for example, an USB flash drive, a removable hard disk, a read-only memory (ROM, Read-Only Memory), a random access memory (RAM, Random Access Memory), a magnetic disk, or an optical disc, or a terminal device, for example, a computer, a server, a mobile phone, or a tablet computer.

The terms “first”, “second”, “third”, and the like in the present disclosure are merely intended for a purpose of description, and shall not be understood as an indication of a quantity of indicated technical features. Therefore, a feature limited by “first”, “second”, or “third” may explicitly or implicitly include at least one of the features. All directional indications (for example, up, down, left, right, front, rear . . . ) in embodiments of the present disclosure are merely intended for explaining a relative position relationship, movement, and the like of components in a specific posture (as shown in the accompanying drawings), and the directional indications correspondingly change if the particular posture changes. In addition, the terms “include”, “have”, and any variants thereof are intended to cover non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

The above description describes only embodiments of the present disclosure and is not intended to limit the scope of the present disclosure. Any equivalent structure or equivalent process transformation performed based on the contents of this specification and the accompanying drawings of the present disclosure or applied directly or indirectly in other related technical fields shall fall within the protection scope of the present disclosure.

What is claimed is:

1. A cleaning system, comprising a swimming pool robot and a base station, wherein:
the swimming pool robot is configured to at least clean liquid in a swimming pool, and the swimming pool robot comprises:
a body;
a first filtering box, wherein the first filtering box is at least partially provided in the body and is configured to filter liquid entering the first filtering box; and
at least one debris discharge opening, wherein the at least one debris discharge opening is configured to at least allow debris in the first filtering box to be discharged from the swimming pool robot,
wherein the base station comprises:
a second filtering box, wherein the second filtering box is configured to filter liquid entering the second filtering box; and
at least one debris inlet, wherein the at least one debris inlet communicates with the second filtering box,
wherein when the swimming pool robot returns to the base station in the swimming pool, the at least one debris inlet communicates with the at least one debris discharge opening, the second filtering box is at least partially located below a water surface of the swimming pool, and the debris in the first filtering box enters the second filtering box through the at least one debris discharge opening and the at least one debris inlet under a suction force.

2. The cleaning system according to claim 1, wherein the at least one debris discharge opening is provided on a bottom or a side portion of the swimming pool robot.

3. The cleaning system according to claim 1, wherein the swimming pool robot comprises:
a liquid inlet portion, wherein the liquid inlet portion is configured to allow the liquid in the swimming pool to enter the first filtering box,
wherein the liquid inlet portion comprises at least:
a first water inlet, wherein the first water inlet is provided on a bottom of the body or a bottom of the first filtering box and is configured for the swimming pool robot to clean a bottom or a wall of the swimming pool; and/or
a second water inlet, wherein the second water inlet is provided on a front portion or a rear portion of the swimming pool robot and is configured for the swimming pool robot to clean the water surface,
wherein the first water inlet or the second water inlet serves as the at least one debris discharge opening.

4. The cleaning system according to claim 1, wherein the swimming pool robot comprises:
a liquid inlet portion, wherein the liquid inlet portion is configured to allow the liquid in the swimming pool to enter the first filtering box,
wherein the liquid inlet portion comprises at least:
a first water inlet, wherein the first water inlet is at least partially provided on a bottom of the body or a bottom of the first filtering box and is configured for the swimming pool robot to clean a bottom or a wall of the swimming pool,
wherein the at least one debris discharge opening is provided on the bottom of the body or the bottom of the first filtering box and is different from the first water inlet.

5. The cleaning system according to claim 4, wherein the first water inlet is provided on the bottom of the first filtering box, the at least one debris discharge opening is provided on the bottom of the first filtering box, and the at least one debris discharge opening and the first water inlet are arranged in a staggered manner.

6. The cleaning system according to claim 1, wherein the swimming pool robot further comprises:
at least one cleaning water inlet, wherein the at least one cleaning water inlet is provided on the body, is in fluid communication with the first filtering box, and is configured to allow water for cleaning the first filtering box to enter the first filtering box,
wherein the at least one cleaning water inlet, the first filtering box, the at least one debris discharge opening, the at least one debris inlet, and the second filtering box are sequentially in fluid communication to form a third water flow path for cleaning the first filtering box.

7. The cleaning system according to claim 6, wherein the swimming pool robot comprises:
a liquid inlet portion, wherein the liquid inlet portion is configured to allow the liquid in the swimming pool to enter the first filtering box,
wherein the liquid inlet portion comprises at least:
a first water inlet, wherein the first water inlet is provided on a bottom of the body or a bottom of the first filtering box and is configured for the swimming pool robot to clean a bottom or a wall of the swimming pool; and/or
a second water inlet, wherein the second water inlet is provided on a front portion or a rear portion of the swimming pool robot and is configured for the swimming pool robot to clean the water surface,
wherein the first water inlet or the second water inlet serves as the at least one cleaning water inlet.

8. The cleaning system according to claim 6, wherein the swimming pool robot further comprises:
a liquid outlet portion, wherein the liquid outlet portion is at least partially provided on a top of the body and is configured to allow liquid filtered by the first filtering box to be discharged from the swimming pool robot,
wherein the liquid outlet portion comprises at least one first water outlet,
wherein the at least one first water outlet serves as the at least one cleaning water inlet.

9. The cleaning system according to claim 6, wherein the swimming pool robot further comprises:
a putting-in and taking-out opening, wherein the putting-in and taking-out opening is at least partially provided on a top of the body and is configured to allow the first filtering box to be put in or taken out from the body,
wherein the putting-in and taking-out opening serves as the at least one cleaning water inlet or the at least one debris discharge opening.

10. The cleaning system according to claim 6, wherein the at least one cleaning water inlet is at least partially located below the water surface, enabling the liquid in the swimming pool to serve as the water for cleaning the first filtering box.

11. The cleaning system according to claim 1, further comprising:
at least one power assembly, wherein the at least one power assembly is configured to generate the suction force and is provided in the base station and/or the swimming pool robot,
wherein when the at least one power assembly is provided in the base station and the at least one power assembly is located downstream of the second filtering box.

12. The cleaning system according to claim 11, wherein the swimming pool robot comprises:
a liquid inlet portion, wherein the liquid inlet portion is provided on the body or the first filtering box and is configured to allow the liquid in the swimming pool to enter the first filtering box;
a liquid outlet portion, wherein the liquid outlet portion is provided on the body and is configured to allow liquid filtered by the first filtering box to be discharged from the swimming pool robot; and
a suction assembly, wherein the suction assembly is at least partially provided in the body and is configured to generate the suction force,
wherein the liquid inlet portion, the first filtering box, an impeller of the suction assembly, and the liquid outlet portion are sequentially in fluid communication to form a cleaning water flow path for cleaning the liquid in the swimming pool; and the suction assembly serves as the at least one power assembly, and the liquid outlet portion, the impeller of the suction assembly, the first filtering box, the at least one debris discharge opening, the at least one debris inlet, and the second filtering box are sequentially in fluid communication to form a third water flow path for cleaning the first filtering box,
wherein when the swimming pool robot performs cleaning, the suction assembly rotates forward to drive liquid to flow along the cleaning water flow path; and
when the swimming pool robot returns to the base station, the suction assembly rotates reversely to drive liquid to flow along the third water flow path to clean the first filtering box.

13. The cleaning system according to claim 1, wherein the base station further comprises:
a base station body, wherein the base station body comprises a third accommodating cavity, wherein the second filtering box is at least partially located in the third accommodating cavity,
wherein the at least one debris inlet communicates with the third accommodating cavity, at least enabling the debris to enter the second filtering box through the at least one debris inlet,
wherein the base station body is further provided with a water discharge opening communicating with the third accommodating cavity, wherein the water discharge opening is configured to allow liquid filtered by the second filtering box to be discharged from the base station body.

14. The cleaning system according to claim 13, wherein the base station further comprises:
a liquid discharge channel, wherein the liquid discharge channel is provided on the base station body, one end of the liquid discharge channel communicates with the third accommodating cavity, and the other end of the liquid discharge channel serves as the water discharge opening; and
a power assembly, wherein the power assembly is configured to generate the suction force and is provided in the liquid discharge channel,
wherein the water discharge opening is at least partially located below the water surface of the swimming pool.

15. The cleaning system according to claim 13, wherein the base station further comprises a fixing seat, wherein the base station body is connected to the fixing seat, and the fixing seat is mounted on a poolside, enabling the base station body to be located in the swimming pool, so that the second filtering box is at least partially located below the water surface.

16. The cleaning system according to claim 13, wherein the at least one debris inlet is provided on the base station body; or
the base station further comprises: a carrying member, wherein the carrying member is substantially perpendicular to a side portion of the base station body to be connected to the base station body,
wherein the at least one debris inlet is provided on the carrying member, wherein the carrying member is provided with a first flow channel, wherein the at least one debris inlet communicates with the third accommodating cavity through the first flow channel.

17. The cleaning system according to claim 13, wherein the swimming pool robot further comprises:
at least one cleaning water inlet, wherein the at least one cleaning water inlet is provided on the body, is in fluid communication with the first filtering box, and is configured to allow water for cleaning the first filtering box to enter the first filtering box,
wherein the at least one cleaning water inlet is at least partially located below the water surface of the swimming pool, and the water discharge opening is at least partially located below the water surface of the swimming pool,
wherein the liquid in the swimming pool is discharged into the swimming pool through the at least one cleaning water inlet, the first filtering box, the at least one debris discharge opening, the at least one debris inlet, the second filtering box, and the water discharge opening under the suction force.

18. The cleaning system according to claim 1, wherein the base station further comprises a first docking assembly, and the swimming pool robot further comprises a second docking assembly,
wherein when the swimming pool robot returns to the base station, the first docking assembly is connected to the second docking assembly, enabling the swimming pool robot to be fixed on the base station; and
when the first docking assembly is separated from the second docking assembly, the swimming pool robot leaves the base station.

19. The cleaning system according to claim 18, wherein the first docking assembly and the at least one debris discharge opening are provided on a same wall of the swimming pool robot, and the second docking assembly and the at least one debris inlet are provided on a same wall of the base station.

20. The cleaning system according to claim 1, wherein the swimming pool robot moves back to the base station on a wall of the swimming pool, or the swimming pool robot moves back to the base station on the water surface of the swimming pool.
